(19) United States
(12) Patent Application Publication
(10) Pub. No.: US 2026/0332746 A1
(43) Pub. Date: Oct. 22, 2026

(54) INTER-PREDICTED REFERENCE PICTURE LISTS

(71) Applicant: Telefonaktiebolaget LM Ericsson (publ), Stockholm (SE)

(72) Inventors: Rickard SJÖBERG, Stockholm (SE); Martin PETTERSSON, Vallentuna (SE); Jacob STRÖM, Stockholm (SE)

(73) Assignee: Telefonaktiebolaget LM Ericsson (publ), Stockholm (SE)

(21) Appl. No.: 19/119,441

(22) PCT Filed: Oct. 10, 2023
(86) PCT No.: PCT/SE2023/051012

§ 371 Date: Apr. 9, 2025

Related U.S. Application Data
(60) Provisional application No. 63/415,716, filed on Oct. 13, 2022.

(51) Int. Cl. H04N 19/105; H04N 19/70

(52) U.S. Cl. CPC H04N 19/105; H04N 19/70

(57) ABSTRACT

There is provided a method for decoding a video bitstream. The method comprises constructing a list of lists, LOL, before any coded picture that references the LOL is decoded, the LOL comprising an entry comprising i) a first previous reference picture list, the L1pred_prev list, and ii) a second previous reference picture list, the L1pred_prev list, wherein the L1pred_prev list comprises a first set of values and the L1pred_prev list comprises a second set of values, and further wherein each value included in the first set of values and the second set of values represents a reference picture indicator that can be used in the decoding process of a coded picture. The method comprises constructing a first current reference picture list, the L1pred_cur list, and a second current reference picture list, the L1pred_cur list, based on the L1pred_prev list and the L1pred_prev list, wherein constructing the L0pred_cur list and L1pred_cur list comprises: deriving a value, the deltaPOC value, from a set of syntax elements in the bitstream, deriving a set of values, the UniqueList, wherein the UniqueList comprises a) the deltaPOC value and b) a third set of values, wherein each value in the third set of values is equal to either i) the sum of a value from the first set of values and the deltaPOC value or ii) the sum of a value from the second set of values and the deltaPOC value, deriving a value N from the set of syntax elements, deriving a value M from the set of syntax elements, including N values from the UniqueList in the L0pred_cur list and including M values from the UniqueList in the L1pred_cur list.

### TECHNICAL FIELD

Disclosed are embodiments related to video encoding and video decoding.

### BACKGROUND

### 1. Versatile Video Coding (VVC) and High-Efficiency Video Coding (HEVC)

Versatile Video Coding (VVC) and its predecessor, High Efficiency Video Coding (HEVC), are block-based video codecs standardized and developed jointly by ITU-T and MPEG. The codecs utilize both temporal and spatial prediction. Spatial prediction is achieved using intra (I) prediction from within the current picture. Temporal prediction is achieved using uni-directional (P) or bi-directional inter (B) prediction on the block level from previously decoded reference pictures.

In the encoder, the difference between the original sample data and the predicted sample data, referred to as the residual, is transformed into the frequency domain, quantized, and then entropy coded before transmitted together with necessary prediction parameters such as prediction mode and motion vectors, also entropy coded. The decoder performs entropy decoding, inverse quantization, and inverse transformation to obtain the residual, and then adds the residual to an intra or inter prediction to reconstruct a picture.

The VVC version 1 specification was published as Rec. ITU-T H.266|ISO/IEC 23090-3, “Versatile Video Coding,” in 2020. MPEG and ITU-T are working together within the Joint Video Exploratory Team (JVET) on updated versions of HEVC and VVC as well as the successor to VVC, i.e., the next generation video codec.

### 2. Components

A video sequence consists of a series of pictures where each picture consists of one or more components. A picture in a video sequence is sometimes denoted ‘image’ or ‘frame’. Each component in a picture can be described as a two-dimensional rectangular array of picture sample values (or “sample values” or “samples” for short). It is common that a picture in a video sequence consists of three components; one luma component Y where the sample values are luma values and two chroma components Cb and Cr, where the sample values are chroma values. Other common representations include ICtCb, IPT, constant-luminance YCbCr, YCoCg and others. It is also common that the dimensions of the chroma components are smaller than the luma components by a factor of two in each dimension. For example, the size of the luma component of an HD picture would be 1920×1080 and the chroma components would each have the dimension of 960×540. Components are sometimes referred to as ‘color components’, and other times as ‘channels’.

### 3. Coding Units and Coding Blocks

In many video coding standards, such as HEVC and VVC, each component of a picture is split into blocks and the coded video bitstream consists of a series of coded blocks. A block is a two-dimensional array of samples. It is common in video coding that the picture is split into units that cover a specific area of the picture.

Each unit consists of all blocks from all components that make up that specific area and each block belongs fully to one unit. The macroblock in H.264 and the Coding Unit (CU) in HEVC and VVC are examples of units. In VVC the CUs may be split recursively to smaller CUs. The CU at the top level is referred to as the coding tree unit (CTU). A CU usually contains three coding blocks, i.e. one coding block for luma and two coding blocks for chroma. A block to which a transform used in coding is applied is referred to as a “transform block.” And a block to which a prediction mode is applied is referred to as a “prediction blocks.”

### 4. Network Abstraction Layer (NAL)

HEVC and VVC define a Network Abstraction Layer (NAL). A NAL unit is a data structure that contains data. A so-called Video Coding Layer (VCL) NAL unit contains data that represents picture sample values. A non-VCL NAL unit contains additional associated data such as parameter sets and supplemental enhancement information (SEI) messages. The NAL unit in HEVC begins with a 2-byte header which specifies the NAL unit type of the NAL unit that identifies what type of data is carried in the NAL unit, the layer ID and the temporal ID for which the NAL unit belongs to. The NAL unit type is transmitted in the nal_unit_type codeword in the NAL unit header and the type indicates and defines how the NAL unit should be parsed and decoded. The bytes after the 2-byte NAL unit header is payload of the type indicated by the NAL unit type. A bitstream consists of a series of concatenated NAL units

### 5. Slices and Tiles

The concept of slices in HEVC divides the picture into independently coded slices, where decoding of one slice in a picture is independent of other slices of the same picture. Different coding types could be used for slices of the same picture, i.e. a slice could either be an I-slice, P-slice or B-slice. One purpose of slices is to enable resynchronization in case of data loss. In HEVC, a slice is a set of CTUs.

The VVC and HEVC video coding standards includes a tool called tiles that divides a picture into rectangular spatially independent regions. Tiles in VVC are similar to the tiles used in HEVC. Using tiles, a picture in VVC can be partitioned into rows and columns of CTUs where a tile is an intersection of a row and a column.

In VVC, a slice is defined as an integer number of complete tiles or an integer number of consecutive complete CTU rows within a tile of a picture that are exclusively contained in a single NAL unit. In VVC, a picture may be partitioned into either raster scan slices or rectangular slices. A raster scan slice consists of a number of complete tiles in raster scan order. A rectangular slice consists of a group of tiles that together occupy a rectangular region in the picture or a consecutive number of CTU rows inside one tile. Each slice has a slice header comprising syntax elements. Decoded slice header values from these syntax elements are used when decoding the slice. Each slice is carried in one VCL NAL unit. In an early draft of the VVC specification, slices were referred to as tile groups.

### 6. Parameter Sets

HEVC and VVC specifies three types of parameter sets, the picture parameter set (PPS), the sequence parameter set (SPS) and the video parameter set (VPS). The PPS contains data that is common for a whole picture, the SPS contains data that is common for a coded video sequence (CVS) and the VPS contains data that is common for multiple CVSs, e.g., data for multiple scalability layers in the bitstream.

VVC also specifies one additional parameter set, the adaptation parameter set (APS). The APS carries parameters needed for the adaptive loop filter (ALF) tool, the luma mapping and chroma scaling (LMCS) tool and the scaling list tool.

Both HEVC and VVC allow certain information (e.g., parameter sets) to be provided by external means. “By external means” should be interpreted as the information is not provided in the coded video bitstream but by some other means not specified in the video codec specification, e.g., via metadata possibly provided in a different data channel, as a constant in the decoder, or provided through an API to the decoder.

### 7. Picture Header

The current VVC draft includes a picture header syntax structure. This syntax structure can either be conveyed in its own NAL unit or be included in a slice header when there is only one slice in the picture. When conveyed in a NAL unit, the NAL unit type is equal to a value that indicates that the NAL unit contains a picture header. The values of the syntax elements in the picture header are used to decode all slices of one picture.

### 8. Decoding Capability Information (DCI)

In VVC there is a DCI NAL unit. The DCI specifies information that doesn't change during the decoding session and may be good for the decoder to know about early and upfront, such as profile and level information. The information in the DCI is not necessary for operation of the decoding process. In drafts of the VVC specification the DCI was called decoding parameter set (DPS).

The decoding capability information may also contain a set of general constraints for the bitstream, that gives the decoder information of what to expect from the bitstream, in terms of coding tools, types of NAL units, etc. In VVC version 1, the general constraint information can be signaled in the DCI, VPS or SPS.

### 9. Decoded Picture Buffer (DPB)

Decoded pictures are stored by the decoder so that they can be used for temporal prediction when decoding future pictures. Those pictures are commonly stored in a decoded picture buffer (DPB). The DPB conceptually consists of a limited number of picture buffers where each picture buffer holds all sample data and motion vector data that may be needed for decoding of future pictures. In HEVC, sample data is needed for motion compensation and motion vector data is needed for temporal motion vector prediction (TMVP). Each picture in the DPB is marked as either “used for short-term reference”, “used for long-term reference”, or “unused for reference”. A picture is stored in the DPB either because it may be used for prediction during decoding or because it is waiting for output. The DPB has a limited size that limits the amount of memory the decoder needs to allocate as well as the number of reference pictures an encoder may use. The memory size is specified by a bitstream level that can be indicated in the bitstream or signaled by the system. A decoder is typically claiming conformance to a specific level which means that it is capable of decoding all bitstreams conforming to that level and lower levels. The decoder may allocate the maximum number of bytes specified by the level and be certain that all bitstreams of that level and lower are decodable.

### 10. Picture Order Count (POC)

Pictures in HEVC are identified by their picture order count (POC) values, also known as full POC values. Each slice contains a code word, pic_order_cnt_lsb, that shall be the same for all slices in a picture. pic_order_cnt_lsb is also known as the least significant bits (lsb) of the full POC since it is a fixed-length code word and only the least significant bits of the full POC is signaled. Both encoder and decoder keep track of POC and assign POC values to each picture that is encoded/decoded. The pic_order_cnt_lsb can be signaled by 4-16 bits. There is a variable MaxPicOrderCntLsb used in HEVC and VVC which is set to the maximum pic_order_cnt_lsb value plus 1. This means that if 8 bits are used to signal pic_order_cnt_lsb, the maximum value is 255 and MaxPicOrderCntLsb is set to 2\hat{ }8=256. The picture order count value of a picture is called PicOrderCntVal in HEVC and VVC. Usually, PicOrderCntVal for the current picture is simply called PicOrderCntVal.

### 11. Reference Picture Set

Reference Picture Sets are a concept in HEVC that defines how previously decoded pictures are managed in a decoded picture buffer (DPB) in order to be used for reference, i.e., sample data prediction and motion vector prediction. In other words, what pictures to store in memory is in HEVC signaled using RPS. An RPS is a set of indicators to previously decoded pictures and the RPS is signalled or indicated in each slice header. An RPS is signaled in each slice header in HEVC. All pictures in the DPB that are not included in the RPS are marked as “unused for reference”. Once a picture has been marked “unused for reference” it can no longer be used for prediction, and when it is no longer needed for output, it will be removed from the DPB. In HEVC, the RPS is signalled as a set of delta POC values relative to a current picture. As an example, the RPS information may contain the values −4, −6, 4

This then means that given that the picture has a POC value equal to 100, the current picture can use the pictures having POC values equal to 96, 94 and 104 for prediction. In this example, the RPS also indicates that any picture having any other POC value will never be used for predication in the future. This is a robust way for the decoder to discard pictures.

Sometimes the encoder may want the decoder to save a picture although it is not going to be used for prediction in the current frame. This is signaled by a flag for each value called used_by_curr_pic_flag. If used_by_curr_pic_flag is equal to 1, this means that the picture can indeed be used for prediction for the current frame. If it is equal to 0, this instead means that the decoder cannot predict from it, but it must keep it in the DPB since future pictures may predict from it. We may use the convention that if a reference picture is marked by a star (*), then used_by_curr_pic_flag equals 0, otherwise used_by_curr_pic_flag equals 1. Hence −4, −6*, 4 means that the decoder may predict from the POC==96 and POC==104 pictures, but not from the POC==94 picture. Still, the decoder cannot throw away the 94 pictures since it may be used for prediction by future pictures.

### 12. RPS in the SPS

Sometimes the RPS information can be rather lengthy. As an example, taken from the configuration files used for test purposes during the standardization of HEVC, the following RPS is used: −3, −2, 1, 2, 5, 6.

Encoding these values may take up 33 bits. Not much perhaps, but if it has to be sent every slice this still amounts to something noticeable, especially at very low bit rates and small image sizes. One key observation however is that these RPSes are typically not completely random. Instead, they can be reused over and over again. As an example, let us go through an example of 18 pictures using a so-called GOP size of 8 pictures. As said above, pictures in HEVC are identified by their POC values, also known as full POC values or picture order count values (PicOrderCntVal). This is the output order (also referred to as the display order); for instance, a picture with POC value==57 will be displayed after a picture with POC value==56. However, the images are not always transmitted in the order they are displayed. For instance, the encoder may first transmit the picture with POC=0, followed by POC=8, followed by POC=4 and so forth. The decoder has to keep track of these and display them in the correct order. In our example, the 18 pictures will be transmitted in the order shown in Table 1 below.

TABLE 1
RPS Example

| POC | Reference Picture Set (RPS) |
|---|---|
| 0 | intra image - - - does not |
| | reference other images |
| 8 | −8 |
| 4 | −4, 4 |
| 2 | −2, 2, 6 |
| 6 | −2, −4, −6, 2 |
| 1 | −1, 1, 3, 5, 7 |
| 3 | −1, −3, 1, 3, 5 |
| 5 | −1, −5, 1, 3 |
| 7 | −1, −3, 1 |
| 16 | −8 |
| 12 | −4, 4 |
| 10 | −2, 2, 6 |
| 14 | −2, −4, −6, 2 |
| 9 | −1, 1, 3, 5, 7 |
| 11 | −1, −3, 1, 3, 5 |
| 13 | −1, −5, 1, 3 |
| 15 | −1, −3, 1 |
| 24 | −8 |

As can be seen in the Table, the RPSes are sent several times. For instance, the RPS sent for POC==6, {−2, −4, −6, 2} is the same as the one sent for POC==14. Due to this periodicity, the HEVC standard allows the RPSes to be sent in the Sequence Parameter Set (SPS). SPS may be sent only once per sequence, or as often as it is desired to have random access possibility. For instance, if the bit stream is broadcasted, an SPS might be sent once a second, to support channel switching once a second. For our example, we could in HEVC specify the eight recurring RPSes in the SPS and assign an index to each one of them as shown in Table 2:

TABLE 2
RPSes stored in SPS

| index | RPS |
|---|---|
| 0 | −8 |
| 1 | −4, 4 |
| 2 | −2, 2, 6 |
| 3 | −2, −4, −6, 2 |
| 4 | −1, 1, 3, 5, 7 |
| 5 | −1, −3, 1, 3, 5 |
| 6 | −1, −5, 1, 3 |
| 7 | −1, −3, 1 |

The information sent in the slice header now only has to refer to an index in the SPS. This is much cheaper than sending the RPSes themselves, as can be guessed from comparing Table 3 and Table 1:

TABLE 3
RPSes in slice header sent using indices to SPS

| POC | RPS index in SPS |
|---|---|
| 0 | intra image |
| 8 | 0 |
| 4 | 1 |
| 2 | 2 |
| 6 | 3 |
| 1 | 4 |
| 3 | 5 |
| 5 | 6 |
| 7 | 7 |
| 16 | 0 |
| 12 | 1 |
| 10 | 2 |
| 14 | 3 |
| 9 | 4 |
| 11 | 5 |
| 13 | 6 |
| 15 | 7 |
| 24 | 0 |

### 13. Prediction of RPSs in the SPS

Coding according to Table 3 reduces the number of bits spent on sending RPSs. The bulk of the data is sent in the SPS instead, which is fine because it is not sent often. Still, it turns out it is possible to compress this information further. If we look at two rows from Table 1, we will see that there is often a correlation between the rows. For instance, if we compare the RPS values for POC=6 (i.e., −2, −4, −6, 2) to the RPS values for POC=1 (i.e., −1, 1, 3, 5, 7), a pattern is revealed as shown in Table 4.

TABLE 4

| POC = 6 | POC = 6 + 5 | POC = 1 | POC = 1 − 5 |
|---|---|---|---|
| −2 | 3 | −1 | −6 |
| −4 | 1 | 1 | −4 |
| −6 | −1 | 3 | −2 |
| 2 | 7 | 5 | 0 |
| | | 7 | 2 |

That is, every number in the RPS for POC=6 plus the value 5 is equal to a number in the RPS for POC=1. For example, the first value −2 plus 5 is equal to 3, which is a value in POC=1. Similarly, every number in the RPS for POC=1 minus the value 5 is equal to a number in the RPS for POC=6, with the only exception being the second to last number 5 which corresponds to the difference between the POC values of the rows, 6−1=5. As it turns out, every row of RPS data can often be predicted from the previous row. This is the case because the RPS of a picture that immediately follows another picture can only contain indicators to pictures in the RPS of that previous picture plus an indicator to the previous picture itself. This is utilized in the HEVC specification with the syntax shown in Table 5.

The value to add (or subtract) (5 in our example) corresponds to the syntax elements delta_rps_sign and abs_delta_rps_minus1 in Table 5.

The HEVC decoder takes the RPS of the previous row in Table 2, adds an element equal to 0 to the set, and then adds the decoded delta number (5 in our example) to every element in the set. The result is a set of candidate pictures for the current RPS.

In the example in Table 4 above, the decoder would take the set −2, −4, −6, 2, add the element 0 and add 5 to each element. This results in the set 3, 1, −1, 7, 5. Then, what pictures to keep and the value of the flag used_by_curr_pic_flag must be signaled. In our example above, used_by_curr_pic_flag is equal to one everywhere since we do not have any RPS entries marked with stars (*). In HEVC, these two types of information are coded together. If we should keep the candidate and used_by_curr_pic_flag is equal to one, we send the code ‘1’. If we should keep the candidate but used_by_curr_pic_flag is zero, we send the code ‘01’. If we should not keep the candidate, we send the code ‘00’. In our example we would send ‘1’ (we should keep −2+5=3, flag=1), ‘1’ (we should keep −4+5=1, flag=1), ‘1’ (we should keep −6+5=−1, flag=1), ‘1’ (we should keep 2+5=7, flag=1) and finally ‘1’ (we should keep 5, flag=1).

TABLE 5
Short-term reference picture set syntax
of HEVC. Used for RPS in SPS signaling

| | Descriptor |
|---|---|
| st_ref_pic_set( stRpsIdx ) { | |
| if( stRpsIdx != 0 ) | |
| inter_ref_pic_set_prediction_flag | u(1) |
| if( inter_ref_pic_set_prediction_flag ) { | |
| if( stRpsIdx = = num_short_term_ref_pic_sets ) | |
| delta_idx_minus1 | ue(v) |
| delta_rps_sign | u(1) |
| abs_delta_rps_minus1 | ue(v) |
| for( j = 0; j <= NumDeltaPocs[ RefRpsIdx ]; j++ ) { | |
| used_by_curr_pic_flag[ j ] | u(1) |
| if( !used_by_curr_pic_flag[ j ] ) | |
| use_delta_flag[ j ] | u(1) |
| } | |
| } | |
| else { | |
| num_negative_pics | ue(v) |
| num_positive_pics | ue(v) |
| for( i = 0; i < num_negative_pics; i++ ) { | |
| delta_poc_s0_minus1[ i ] | ue(v) |
| used_by_curr_pic_s0_flag[ i ] | u(1) |
| } | |
| for( i = 0; i < num_positive_pics; i++ ) { | |
| delta_poc_s1_minus1[ i ] | ue(v) |
| used_by_curr_pic_s1_flag[ i ] | u(1) |
| } | |
| } | |
| } | |

By sending the data this way, a lot of bits can be saved. The savings obtained in HEVC is about 50% of the RPS bits. Still of course, the RPS data is a very small part of the total video bit stream data, so the overall effect may not be large, but it is of course beneficial to compress the data efficiently.

### 14. Reference Picture Lists

When decoding a picture, references to previous pictures are handled by reference picture lists. HEVC uses at most two reference picture lists, L0 and L1 for each picture, and those lists may only contain pictures in the RPS that are set to “used by cur pic”. P-pictures uses L0 and B-pictures uses L0 and L1. When inter prediction is used for a block, the decoder derives a reference index value for L0, and possibly L1, and uses those reference index values as indices in the L0 and L1 lists to determine which reference picture(s) to use for the block.

### 15. Reference Picture Set in VVC

VVC uses parts of the reference picture set idea, but instead of signaling the RPS as in HEVC, the VVC specification allows signaling of the L0 and L1 lists in the SPS. For each of the L0 and L1 lists, the number of “active” pictures is signalled in the PPS with an option to override this number in the slice header. Active pictures are reference pictures that are kept in the DPB and can be used for reference by the current picture while inactive pictures must be kept in the DPB but are not used for reference by the current picture. Inactive pictures correspond to pictures with used_by_curr_pic_flag equal to 0 in HEVC.

When the L0 and L1 lists in VVC are signaled in the SPS, the decoder can be seen as constructing one list of L0 lists and one list of L1 lists. Each entry in those two lists is a reference picture list. FIG. 4 shows an example.

The SPS syntax in VVC for conveying these lists to the decoder includes an sps_num_ref_pic_lists[0] codeword that specifies the size of the list of L0 lists. For the example shown in FIG. 4, that size is equal to 3. Then, for each of the 3 entries, the codewords in the ref_pic_list_struct( ) syntax structure as specified in VVC, not shown here, follows. This syntax structure includes a codeword for the size of the L0 list followed by codewords specifying the values of the L0 list. In the FIG. 4 example, the sizes of the three L0 lists are all equal to 5. Thereafter, the sps_num_ref_pic_lists[1] codeword follows, that specifies the size of the list of L1 lists with its ref_pic_list_struct( ) syntax following. In the FIG. 4 example, the size of the list of L1 lists is equal to 2 and the sizes of the L1 lists are 2 and 1 respectively.

A VVC decoder may later, when decoding a picture header or slice header, reference L0 and L1 lists that were decoded from the SPS rather than decoding them from the picture header and slice header themselves. If a particular L0 or L1 list is used by many coded pictures that reference the same SPS, it is more bit-efficient if the lists are conveyed in the SPS. When SPS referencing is not done, the picture header or slice header contains a ref_pic_list_struct( ) syntax structure, so the syntax for the L0 and L1 lists is very similar regardless of whether it is positioned in the SPS or picture header or slice header in VVC.

Using FIG. 4 as an example, a VVC decoder may from a ref_pic_lists( ) syntax structure in a picture header or slice header decode a syntax element flag called rpl_sps_flag as equal to 1 for L0. The rpl_sps_flag indicates whether to use an RPL from the SPS or explicitly decode it from the picture header or slice header. Then the next syntax element is an index value that specifies which entry in the list of L0 lists to use. For example, if that index value is equal to 0, then the decoder will use a reference picture list L0 equal to {−32, −64, −48, −40, −36} for the picture associated with the picture header or slice header.

Thereafter, the VVC decoder may decode the flag rpl_sps_flag as equal to 1 for L1 as well, followed by decoding an index value. This index value may for example be equal to 1, which then means that the decoder will use a reference picture list L1 equal to {16}.

### SUMMARY

Certain challenges presently exist. For instance, a problem with the signaling of reference picture lists in VVC is that there is no prediction in the signaling, and this makes the signaling inefficient in terms of compression.

Accordingly, in one aspect there is provided a method for decoding a video bitstream. The method includes constructing a list of lists, LOL, before any coded picture that references the LOL is decoded. The LOL comprises an entry comprising i) a first previous reference picture list, the L0pred_prev list, and ii) a second previous reference picture list, the L1pred_prev list, wherein the L0pred_prev list comprises a first set of values and the L1pred_prev list comprises a second set of values. Each value included in the first set of values and the second set of values represents a reference picture indicator that can be used in the decoding process of a coded picture. The method also includes constructing a first current reference picture list, the L0pred_cur list, and a second current reference picture list, the L1pred_cur list, based on the L0pred_prev list and the L1pred_prev list. Constructing the L0pred_cur list and the L1pred_cur list includes: deriving a value, the deltaPOC value, from a set of syntax elements in the bitstream; deriving a set of values, the UniqueList, wherein the UniqueList comprises a) the deltaPOC value and b) a third set of values, wherein each value in the third set of values is equal to either i) the sum of a value from the first set of values and the deltaPOC value or ii) the sum of a value from the second set of values and the deltaPOC value; deriving a value N from the set of syntax elements; deriving a value M from the set of syntax elements; including N values from the UniqueList in the L0pred_cur list; and including M values from the UniqueList in the L1pred_cur list.

In some aspects, there is provided a computer program comprising instructions which when executed by processing circuitry of an apparatus causes the apparatus to perform any of the methods disclosed herein. In one embodiment, there is provided a carrier containing the computer program wherein the carrier is one of an electronic signal, an optical signal, a radio signal, and a computer readable storage medium. In another aspect there is provided an apparatus that is configured to perform the methods disclosed herein. The apparatus may include memory and processing circuitry coupled to the memory.

An advantage of embodiments disclosed herein is that they provide video compression bit-rate savings.

### BRIEF DESCRIPTION OF THE DRAWINGS

The accompanying drawings, which are incorporated herein and form part of the specification, illustrate various embodiments.

FIG. 1 illustrates a system according to an embodiment.

FIG. 2 is a schematic block diagram of an encoder according to an embodiment.

FIG. 3 is a schematic block diagram of a decoder according to an embodiment.

FIG. 4 illustrates an example of a first list of L0 lists and a second list of L1 lists.

FIG. 5 illustrates an example list of lists.

FIG. 6A is a flowchart illustrating a process according to an embodiment.

FIG. 6B is a flowchart illustrating a process according to an embodiment.

FIG. 7 is a block diagram of an encoding apparatus according to an embodiment.

### DETAILED DESCRIPTION

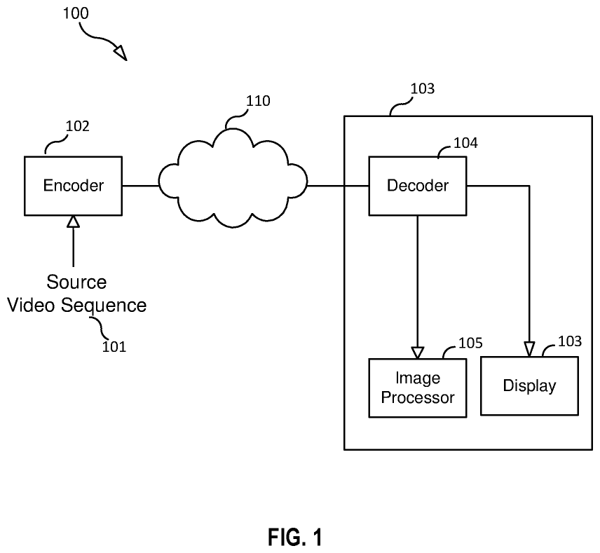

FIG. 1 illustrates a system 100 according to an embodiment. System 100 includes an encoder 102 and a decoder 104, wherein encoder 102 is in communication with decoder 104 via a network 110 (e.g., the Internet or other network). Encoder 102 encodes a source video sequence 101 into a bitstream comprising an encoded video sequence and transmits the bitstream to decoder 104 via network 110. In some embodiments, encoder 102 is not in communication with decoder 104, and, in such an embodiment, rather than transmitting bitstream to decoder 104, the bitstream is stored in a data storage unit. Decoder 104 decodes the coded pictures included in the encoded video sequence to produce video data for display and/or further image processing (e.g. a machine vision task). Accordingly, decoder 104 may be part of a device 103 having an image processor 105 and/or a display 106. The image processor 105 may perform machine vision tasks on the decoded pictures. One such machine vision task may be identifying objects in the picture. The device 103 may be a mobile device, a set-top device, a head-mounted display, or any other device.

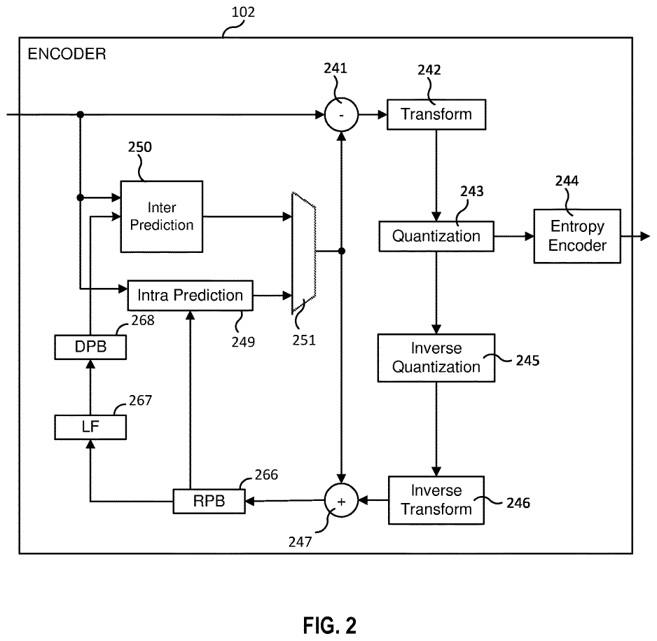

FIG. 2 illustrates functional components of encoder 102 according to some embodiments. It should be noted that encoders may be implemented differently so implementation other than this specific example can be used. Encoder 102 employs a subtractor 241 to produce a residual block which is the difference in sample values between an input block and a prediction block (i.e., the output of a selector 251, which is either an inter prediction block output by an inter predictor 250 (a.k.a., motion compensator) or an intra prediction block output by an intra predictor 249). Then a forward transform 242 is performed on the residual block to produce a transformed block comprising transform coefficients. A quantization unit 243 quantizes the transform coefficients based on a quantization parameter (QP) value (e.g., a QP value obtained based on a picture QP value for the picture in which the input block is a part and a block specific QP offset value for the input block), thereby producing quantized transform coefficients which are then encoded into the bitstream by encoder 244 (e.g., an entropy encoder) and the bitstream with the encoded transform coefficients is output from encoder 102. Next, encoder 102 uses the quantized transform coefficients to produce a reconstructed block. This is done by first applying inverse quantization 245 and inverse transform 246 to the transform coefficients to produce a reconstructed residual block and using an adder 247 to add the prediction block to the reconstructed residual block, thereby producing the reconstructed block, which is stored in the reconstruction picture buffer (RPB) 266. Loop filtering by a loop filter (LF) stage 267 is applied and the final decoded picture is stored in a decoded picture buffer (DPB) 268, where it can then be used by the inter predictor 250 to produce an inter prediction block for the next picture to be processed. LF stage 267 may include three sub-stages: i) a deblocking filter, ii) a sample adaptive offset (SAO) filter, and iii) an Adaptive Loop Filter (ALF).

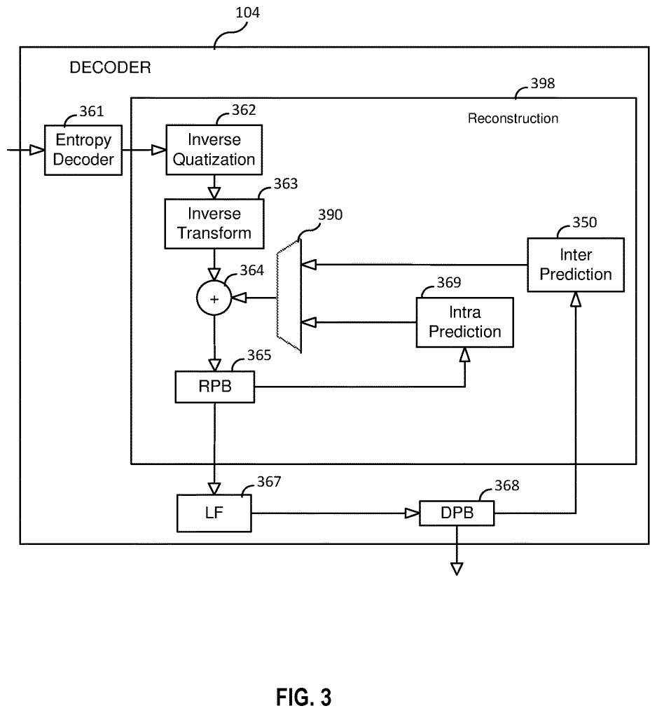

FIG. 3 illustrates functional components of decoder 104 according to some embodiments. It should be noted that decoder 104 may be implemented differently so implementations other than this specific example can be used. Decoder 104 includes a decoder module 361 (e.g., an entropy decoder) that decodes from the bitstream quantized transform coefficient values of a block. Decoder 104 also includes a reconstruction stage 398 in which the quantized transform coefficient values are subject to an inverse quantization process 362 and inverse transform process 363 to produce a residual block. This residual block is input to adder 364 that adds the residual block and a prediction block output from selector 390 to form a reconstructed block. Selector 390 either selects to output an inter prediction block or an intra prediction block. The reconstructed block is stored in a RPB 365. The inter prediction block is generated by the inter prediction module 350 and the intra prediction block is generated by the intra prediction module 369. Following the reconstruction stage 398, a loop filter stage 367 applies loop filtering and the final decoded picture may be stored in a decoded picture buffer (DPB) 368 and output to image processor 105. Pictures are stored in the DPB for two primary reasons: 1) to wait for picture output and 2) to be used for reference when decoding future pictures.

As described above, a challenge presently exists because there is no prediction in the signaling of reference picture lists in VVC, and this makes the signaling inefficient in terms of compression. Accordingly, this disclosure provides, among other things, methods for predicting reference picture list data to increase compression efficiency. In one embodiment, a method for predicting reference picture list data includes generation of a list of lists of picture references without duplicates (called the “UniqueList”) and using this list to generate reference picture lists L0pred and L1pred that may later be used to generate reference picture lists L0 and L1 for a picture. In some embodiments, the method is used for storing reference picture list data in a parameter set. The following additional embodiments are described herein: i) a method using decoding of slice header syntax elements; ii) generation of the lists L0pred and L1pred from UniqueList without explicit syntax; iii) a method using syntax elements to control generation of lists L0pred and L1pred from UniqueList; iv) delta coding of the L0pred and L1pred list lengths; v) using L0pred and L1pred to decode a picture; and vi) a syntax table and pseudocode combining several of the embodiments.

### Embodiment 1—General Methodology

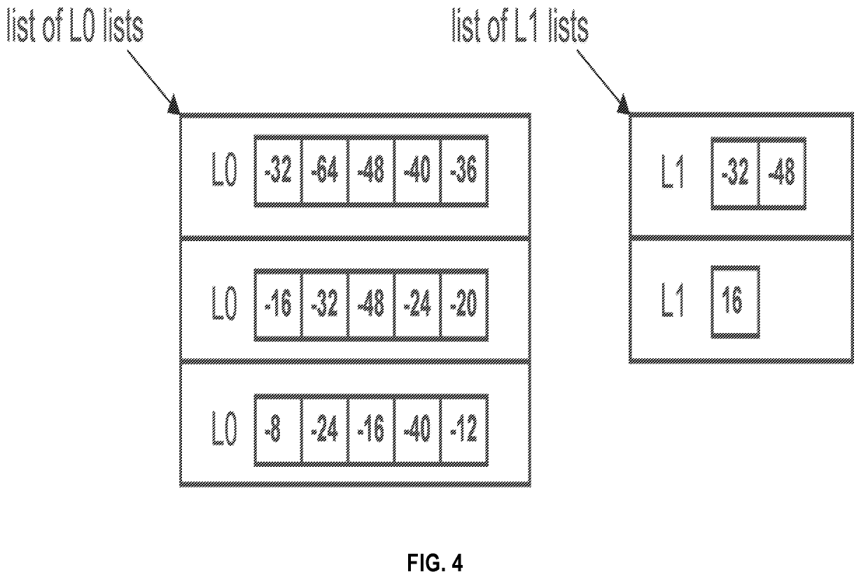

In a first embodiment, predicting reference picture list data is performed using a list of lists (LOL). This is similar to the list of L0 lists and the list of L1 lists in VVC (see FIG. 4), but in this embodiment there is a single list rather than two lists. That is, in this embodiment, each entry in the LOL contains two lists: one L0pred list and one L1pred list.

In this embodiment, the L0pred list and the L1pred list may be used to derive a reference picture list L0 and a reference picture list L1. In one variant, at least one of the L0 list and the L1 list are derived as identical to the L0pred list and the L1pred list, respectively. In another variant, the L0 list and the L1 list are based on the L0pred and L1pred lists, for example by adding PicOrderCntVal to each of the L0pred and L1pred entries.

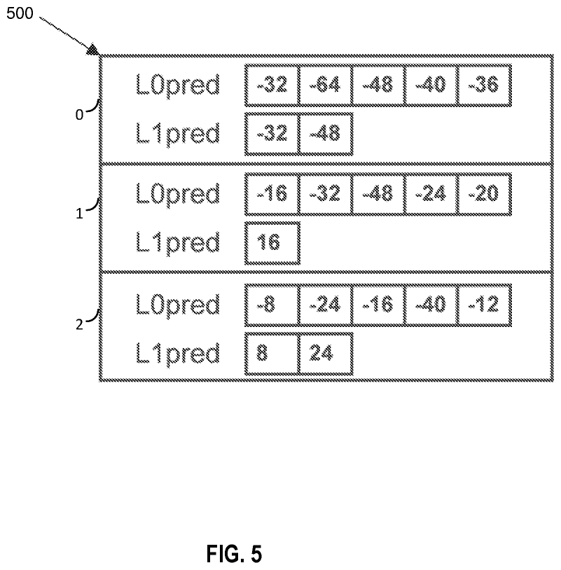

FIG. 5 shows an example LOL (500). In the example, shown, each item of the LOL is a 2-tuple comprising an L0pred list and an L1pred list. The LOL could, however, be split into two LOLs, a first LOL where each entry of the first LOL is an L0pred list and a second LOL where each entry of the second LOL is an L1pred list, as in VVC, but in contrast to VVC, the proposed methodology always uses a single index rather than one index for L0pred and a separate index for L1pred.

In FIG. 5, the LOL has 3 entries (a.k.a., “items” or “elements”): entry 0, entry 1, and entry 2; hence the LOL has a size of 3. Each entry consists of one L0pred list and one L1pred list. The size of the LOL is not a constant. The size may be signaled in a coded video bitstream such that a video decoder will decode the size and then further construct the content of all entries of the LOL from syntax elements in the bitstream.

This disclosure provides a method for decoding a video bitstream that includes constructing a LOL based on elements in the bitstream and then using the LOL to decode one or more pictures. The LOL is preferably constructed before any of the pictures that references the LOL or use the LOL is decoded. This means that the syntax elements from which the LOL is decoded precede all coded pictures that reference the LOL.

As illustrated in FIG. 5, each entry in the LOL may contain two reference picture lists: an L0pred list and an L1pred list. Each value in an L0pred list represents a reference picture indicator that can be used in the decoding process of a coded picture. Likewise, each value in an L1pred list represents a reference picture indicator that can be used in the decoding process of a coded picture.

Furthermore, in one embodiment, a current L0pred list (a.k.a., the L0pred_cur list) and a current L1pred list (a.k.a., the L1pred_cur list) is constructed by prediction from a previous L0pred list (a.k.a., the L0pred_prev list) and a previous L1pred list (a.k.a., the L1pred_prev list) of an entry in the LOL. The current L0pred list and the current L1pred list may or may not be present in the LOL.

The proposed prediction mechanism for predicting a current L0pred list and a current L1pred from a previous L0pred and previous L1pred list of an entry i in the LOL is done as follows.

1) A value, denoted “deltaPOC,” is derived from a set of one or more syntax elements in the bitstream. For example, in one embodiment, deltaPOC is decoded from a single syntax element in the bitstream.

2) A list, denoted “UniqueList,” is derived such that it contains all previous L0pred list values and all previous L1pred list values without duplicates (e.g., the UniqueList is an ordered set of values where the set is the union of the set of values contained in the L0pred_prev list with duplicates removed and the set of values contained in the L1pred_prev list with duplicates removed).

3) Each entry in UniqueList is then modified by adding the value deltaPOC to the value of each entry, thereby producing a modified UniqueList.

4) An additional entry having a value equal to deltaPOC is added to the modified UniqueList, thereby producing a final UniqueList. Alternatively, before step 3 an additional entry having a value equal to 0 can be added to the modified UniqueList, thereby making step 4 unnecessary (in this alternative the modified UniqueList obtained in step 3 is the final UniqueList).

5) The next step comprises deriving the number of entries in the current L0pred list (i.e., deriving the size of the L0pred_cur list) and the number of entries in the current L1pred list (i.e., deriving the size of the L1pred_cur list) from the set of syntax elements. Preferably, the number of entries in the current L0pred and L1pred lists are derived by decoding one syntax element each in the set of syntax elements.

6) Each entry value in the current L0pred list and the current L1pred list is derived using the final UniqueList. For example, if the size of the L0pred_cur list is N, then N values from the final UniqueList are included in the L0pred_cur list. Likewise, if the size of the L1pred_cur list is M, then M values from the final UniqueList are included in the L1pred_cur list.

Accordingly, in one embodiment, a decoder may perform the following two steps.

1) Constructing a LOL before any coded picture that references the LOL is decoded, wherein the LOL comprises at least one entry, and wherein each entry in the LOL contains two reference picture lists L0pred and L1pred, and wherein each value in any of the two reference picture lists L0pred and L1pred is, or represents, a reference picture indicator that can be used in the decoding process of a coded picture.

2) Constructing a current L0pred list and a current L1pred list by predicting from a previous L0pred list and a previous L1pred list of one entry in the LOL. The predicting step includes:
2a) deriving a value deltaPOC from a set of syntax elements in the bitstream;
2b) deriving a list that contains all previous L0pred list values and all previous L1pred list values without duplicates;
2c) modifying each entry in the list by adding the value deltaPOC to the value of each entry, thereby producing a modified list;
2d) adding to the modified list an additional entry having a value equal to deltaPOC, thereby producing a final list (a.k.a., the final UniqueList);
2e) deriving the number of entries in the current L0pred list and the number of entries in the current L1pred list from the set of syntax elements; and
2f) deriving each entry value in the current L0pred and L1pred list from the values in the final UniqueList.

The decoder may further decode a current coded picture from the video bitstream wherein the current L0pred list and the current L1pred list are used in the decoding process of the current coded picture.

As an example, consider LOL 500 shown in FIG. 5. Let the previous L0pred list and the previous L1pred list be from entry 0 of LOL 500. This means that the L0pred_prev list is equal to {−32, −64, −48, −40, −36} and the L1pred_prev list is equal to {−32, −48}. Then the construction of the current L0pred list and the current L1pred list according to steps 2a-2f above may be done as follows:

a) A UniqueList (i.e., a set of numbers) is derived as equal to {−32, −64, −48, −40, −36}, which contains all previous L0pred list values without duplicates and all previous L1pred list values without duplicates. For example, the UniqueList (UL) is the union of the set of numbers specified in the previous L0pred list with duplicates removed (denoted L0pred) and the set of numbers specified in the L1pred list with duplicates removed (denoted L1pred) (i.e., UL E (L0pred∪L1pred)). In this example, neither the L0pred list nor the L1pred lists contains a duplicate, but if one of them had a duplicate value (e.g., if the L1pred list contained numbers {−32, −48, −32}) then the UniqueList would not change (i.e., the UniqueList would still be {−32, −64, −48, −40, −36}).

b) UL is modified by adding a value deltaPOC to the value of each entry in UL, thereby producing a modified UL (ULm). For example, if deltaPOC is equal to 16, then ULm is equal to: {−16, −48, −32, −24, −20}.

c) ULm is modified by adding the value deltaPOC to ULm, thereby producing a final set of values (ULf) (a.k.a., the final UniqueList), which in this example is: {−16, −48, −32, −24, −20, 16}.

d) The number of entries in the current L0pred list is derived as equal to 5 and the number of entries in the current L1pred list is derived as equal to 1. This matches entry 1 in LOL 500.

e) Finally, each entry value in the current L0pred list and the current L1pred list is derived from the values in UniqueList. From FIG. 5 it can be seen that all entries in the current L0pred list and the current L1pred list are present in the final UniqueList. Deriving the entry values of the current L0pred list is then a matter of selecting 5 entries from UniqueList in the correct order and deriving the entry values of the current L1pred list is a matter of selecting 1 entry from UniqueList.

It is much more bit-efficient to signal the values in the current L0pred list and the current L1pred list by using the final UniqueList rather than of signaling the values as-is.

### Embodiment 2: Constructing the Entire LOL when Decoding a SPS or PPS

This embodiment may be combined with embodiment 1. As in embodiment 1, the previous L0pred list and the previous L1pred list are in this embodiment present in an entry in the LOL. In this embodiment they are present in an entry i in the LOL. Additionally, the current L0pred list and the current L1pred list are stored in an entry j in the LOL.

The entry i is an earlier entry than the entry j. In one variant, entry i is the entry immediately preceding entry j such that i is equal to j−1. In this case, the decoder may keep L0pred and L1pred from the previous entry when constructing the contents of entry j. Alternatively, the decoder calculates j−1 and uses that value to find the previous L0pred and L1pred lists in the LOL. In another variant, the entry i is not the entry immediately preceding entry j. In this case, a value representing the delta between i and j may be derived, preferably by decoding a value from the set of syntax elements. This delta value is then used to identify the entry in the LOL containing the previous L0pred and previous L1pred to use.

Referring to FIG. 5, let entry i be the first entry (entry 0) and entry j be the second entry (entry 1). This means that the current L0pred list {−16, −32, −48, −24, −20} is derived using both the previous L0pred list {−32, −64, −48, −40, −36} and the previous L1pred list {−32, −48} for prediction. Additionally, the current L1pred list {16} is also derived using both the previous L0pred list and the previous L1pred list for prediction.

In this embodiment, the set of syntax elements are preferably present in a parameter set syntax structure, for example the DPS (a.k.a. DCI), VPS, SPS, PPS, APS, or any other parameter set.

All entries in the entire LOL are here derived from the parameter set syntax structure. This means that any current L0pred and L1pred lists that are derived are stored in the LOL.

In this embodiment, the prediction mechanism for predicting a current L0pred list and a current L1pred of an entry j in the LOL from a previous L0pred list and a previous L1pred list of an entry i in the LOL is done as follows:

First a value “deltaPOC” is derived from a set of syntax elements in the bitstream. This value may be decoded from a single syntax element in a bitstream. Then the UniqueList is initially derived such that it contains all values from the previous L0pred list and all values from the previous L1pred list, without duplicates. After this initial derivation of UniqueList, the method includes modifying each entry in UniqueList by adding the value deltaPOC to the value of each entry. Thereafter, a new entry with a value equal to deltaPOC is added to UniqueList.

For example, if deltaPOC is equal to 16 and the initially derived UniqueList contains the following elements: {-32, −64, −48, −40, −36}, as they would be if entry i was entry 0 in FIG. 5, then the final UniqueList will include the following elements {−16, −48, −32, −24, −20, 16}.

Next, similarly to embodiment 1, the method includes deriving the number of entries in the current L0pred list and the number of entries in the current L1pred list from the set of syntax elements. In FIG. 5, those would be derived as 5 and 1, respectively.

Finally, each entry value in the current L0pred list and the current L1pred list are derived using UniqueList. Referring again to FIG. 5 with i equal to 0 and j equal to 1, note that all values in the current L0pred and L1pred lists are present in the final UniqueList. Deriving the entry values of the current L0pred list is then a matter of selecting 5 entries from UniqueList in the correct order and deriving the entry values of the current L1pred list is a matter of selecting 1 entry from UniqueList. Embodiments 4 and 5 below contains details on how this may be done.

A decoder may perform the following two steps according to this embodiment:

1) Constructing a LOL before any coded picture that references it is decoded wherein each entry in the LOL contain two reference picture lists L0pred and L1pred, and wherein each value in any of the two reference picture lists L0pred and L1pred is, or represents, a reference picture indicator that can be used in the decoding process of a coded picture.

2) Constructing a current L0pred list and a current L1pred list by prediction from a previous L0pred list and a previous L1pred list of an entry in the LOL, the prediction comprising:
2a) deriving a value deltaPOC from parameter set syntax elements in the bitstream;
2b) deriving a list (UniqueList) that contains all previous L0pred list values and all previous L1pred list values without duplicates;
2c) modifying each entry in UniqueList by adding the value deltaPOC to the value of each entry;
2d) adding an additional entry in UniqueList with the value deltaPOC;
2e) deriving the number of entries in the current L0pred list and the number of entries in the current L1pred list from parameter set syntax elements;
2f) deriving each entry value in the current L0pred and L1pred list from the values in UniqueList; and
2g) storing the current L0pred and L1pred list as an entry in the LOL.

### Embodiment 3: First Constructing the LOL from SPS/PPS Data, then Referencing an Entry in the LOL in the Slice Header and Constructing the Current L0Pred List and the Current L1pred List when Decoding the Slice Header

In contrast to embodiment 2, in this embodiment the set of syntax elements is not present in any parameter set, but instead is associated with a single coded picture. For example, the set of syntax elements may here be one of, or a combination of, video coding layer (VCL) syntax elements, slice header syntax elements, or picture header syntax elements.

As in embodiments 1 and 2, the previous L0pred list and the previous L1pred list are present in an entry i in the LOL. But as previously mentioned, in this embodiment, the current L0pred list and the current L1pred lists are not present or stored in any entry in the LOL. Instead, the current L0pred list and current L1pred list are constructed and used for a current picture only.

A decoder may perform the following two steps according to this embodiment:

1) Constructing a LOL before any coded picture that references the LOL is decoded wherein each entry in the LOL contains two reference picture lists: L0pred and L1pred, and wherein each value in any of the two reference picture lists L0pred and L1pred is, or represents, a reference picture indicator that can be used in the decoding process of a coded picture. The LOL may be derived from parameter set syntax elements in the bitstream.

2) Constructing a current L0pred list and a current L1pred list by prediction from a previous L0pred list and a previous L1pred list of an entry in the LOL. The prediction includes:
2a) deriving a value deltaPOC from a set of syntax elements in the bitstream (e.g., the above mentioned parameter set syntax elements);
2b) deriving an entry value i and using the entry value i as an index for the LOL to identify the previous L0pred list and previous L1pred list in the LOL (the entry value i may be decoded from a syntax element in the set of syntax elements);
2c) deriving a list UniqueList that contains all previous L0pred list values and all previous L1pred list values without duplicates;
2d) modifying each entry in UniqueList by adding the value deltaPOC to the value of each entry;
2e) adding an additional entry in UniqueList with the value deltaPOC;
2f) deriving the number of entries in the current L0pred list and the number of entries in the current L1pred list from the set of syntax elements; and
2g) deriving each entry value in the current L0pred and L1pred list from the values in UniqueList.

The set of syntax elements is one of, or a combination of, VCL syntax elements, slice header syntax elements, or picture header syntax elements.

### Embodiment 4: Deriving Entry Values by Decoding Indices to UniqueList

In this embodiment, a value in the current L0pred list is derived from UniqueList by deriving an index value j then setting the value in current L0pred list equal to the j'th value in UniqueList. A value in the current L1pred list is derived in the same way; by deriving an index value j then setting the value in the current L1pred list equal to the j'th value in UniqueList. That is, for each entry in the current L0pred list (L0pred[ ]), determine an index value (j) and store in said entry of the current L0pred list the j'th value in the UniqueList (i.e., UniqueList[j]). Likewise, for each entry in the current L1pred list (L1pred[ ]), determine an index value (j) and store in said entry of the current L1pred list the j'th value from the UniqueList (i.e., UniqueList[j]).

Pseudo-code to implement the above process is shown below in Table 6:

```
TABLE 6
int L0pred_length = getL0predLength( ); // length of the L0pred list
int L1pred_length = getL1predLength( ); // length of the L1pred list
for (int ii = 0; ii < L0pred_length; ii++){
  int index_value_j = decode_index_value_j( );
  L0pred[ii] = UniqueList[index_value_j];
}
for (int ii = 0; ii < L1pred_length ; ii++){
  int index_value_j = decode_index_value_j( );
  L1pred[ii] = UniqueList[index_value_j];
}
```

The function decode_index_value_j( ) is derives an index value from the set of syntax elements.

In one variant of this embodiment, the index value j is derived as follows:

1) The number of elements, N, in UniqueList is derived.

2) A number of bits to decode, denoted M, is determined as equal to ceil (log 2(N)). Here ceil( ) is the ceiling function and log 2( ) is a 2-logarithm function. The value of M for N=2, 3, 4, . . . , 8 is shown in Table 7 below. The ceil (log 2(N)) operation may be implemented by determining the most significant bit of N or by a bitscan operation as is well-known in the art.

TABLE 7

| N | log2(N) | M = ceil(log2(N)) |
|---|---|---|
| 2 | 1 | 1 |
| 3 | 1.58 | 2 |
| 4 | 2 | 2 |
| 5 | 2.32 | 3 |
| 6 | 2.58 | 3 |
| 7 | 2.81 | 3 |
| 8 | 3 | 3 |

3) The index value j is derived by decoding a syntax element of M bits and either setting j equal to the value V of the decoded syntax element (j=V) or setting j equal to the value V plus 1 (j=V+1).

The entry value in the current L0pred list and/or the entry value in the current L1pred may then be set equal to the value of the j'th entry in UniqueList.

Table 8 below illustrates pseudo-code for populating the current L0pred list and the current L1pred list:

```
TABLE 8
int L0pred_length = getL0predLength( ); //length L0pred list
int L1pred_length = getL1predLength( ); //length L1pred list
int UniqueList_length = getUniqueListLength( ); //length UniqueList list
int M = ceilLog2(UniqueList_length);
for (int ii = 0; ii < L0pred_length; ii++)
  L0pred[ii] = UniqueList[ReadBits(M)+C];
for (int ii = 0; ii < L1pred_length ; ii++)
  L1pred[ii] = UniqueList[ReadBits(M)+C];
```

ReadBits (M) is a function that reads M bits from the bitstream and returns the value of the M bits (e.g., if M=3 and the three bits are 1, 0, 1, then the value returned by ReadBits(3) is 5). C is a constant that may be equal to 0 or 1.

### Embodiment 5: Deriving Entry Values by Constructing Guessed Lists from UniqueList

In this embodiment, the current L0pred list and/or the current L1pred list is/are derived from UniqueList by a different method than the one described in embodiment 4. The method here constructs the list directly from the elements of the UniqueList without any guiding syntax such as the index values j in embodiment 4. One can describe this as the current L0pred list or the current L1pred list is set equal to a “guessed” list, where the guessed list is constructed from the UniqueList alone.

In a preferred variant, there is a flag in the bitstream that specifies whether the guessed list shall be used or not. In one variant, there is a single flag. If this single flag is equal to a predetermined value, then a guessed list is constructed from UniqueList for the current L0pred list and another guessed list is constructed from UniqueList for the current L1pred list. If the single syntax element is not equal to the predetermined value, the current L0pred and L1pred lists are derived by other means.

In another preferred variant there are two separate flags, one for the current L0pred list and one for the current L1pred list. If the flag for the current L0pred list is equal to a predetermined value, a guessed list for L0pred is constructed and used as the current L0pred list. Otherwise, the current L0pred list is derived by other means. The same is done for the current L1pred list.

Table 9 below shows example pseudocode for implementing this embodiment.

```
TABLE 9
int L0pred_length = getL0predLength( ); // length of L0pred list
int L1pred_length = getL1predLength( ); // length of L1pred list
int useGuessedList = ReadBits(1);
if (useGuessedList)
{
  for (int ii = 0; ii < L0pred_length; ii++)
  L0pred[ii] = DeriveListEntryValueL0(ii, UniqueList);
}
useGuessedList = ReadBits(1);
if (useGuessedList)
{
  for (int ii = 0; ii < L1pred_length; ii++)
  L1pred[ii] = DeriveListEntryValueL1(ii, UniqueList);
}
```

The functions DeriveListEntryValueL0(ii, UniqueList) and DeriveListEntryValueL1(ii, UniqueList) select a value from UniqueList without reading any bits to guide the selection. The N elements of the current L0pred list may be set equal to the N first entries in a sorted sequence of the N negative numbers in decreasing order, with the highest negative number first. For instance, if UniqueList is equal to {−3, −1, 5, −6, 3}, then the 3 first entries of the current L0pred list are set equal to {−1, −3, −6, . . . }

Pseudocode for this variant is shown below in Table 10:

TABLE 10
std::vector<int> UniqueList;

| | |
|---|---|
| ConstructUniqueList(UniqueList); // | assume that all elements |
| | are negative |
| int L0pred_length = getL0predLength( ); // | assume the length of the |
| | L0pred list is less than or |
| | equal to the length of |
| | UniqueList |
| sort(UniqueList.begin( ), UniqueList.end( ), greater<int>( )); // | sort in |
| | decreased |
| | order |

```
int useGuessedList = ReadBits(1);
if (useGuessedList){
  for (int ii = 0; ii < L0pred_length; ii++)
    L0pred[ii] = UniqueList[ii];
}
```

In one variant, there are N positive numbers in UniqueList, with N larger than 1, where the N first entries of the current L1pred list are set equal to the N first entries of a sorted sequence of the N positive numbers in increased order. For instance, if UniqueList is equal to {−3, −1, 5, −6, 3}, then the 2 first entries of the current L1pred list are set equal to {3, 5 . . . }.

Pseudocode for this variant is shown below in Table 11:

TABLE 11
std::vector<int> UniqueList;

| | |
|---|---|
| ConstructUniqueList(UniqueList); // | assume that all elements are |
| | positive |
| int L1pred_length = getL1predLength( ); // | assume the length of the |
| | L1pred list is less than or equal |
| | to the length of UniqueList |
| sort(UniqueList.begin( ), UniqueList.end( )); // | sort in increased order |

```
int useGuessedList = ReadBits(1);
if (useGuessedList){
  for (int ii = 0; ii < L1pred_length; ii++)
    L1pred[ii] = UniqueList[ii];
}
```

In another variant, the current L0pred list is first filled with the negative numbers from the UniqueList preferably in decreasing order, followed by the positive numbers from the UniqueList, preferably in increasing order.

For instance, if we use the same example as above with UniqueList equal to {−3, −1, 5, −6, 3}, then the entries of the current L0pred list are set equal to {−1, −3, −6, 3, 5}.

This could also be done for L1 in a similar way. The current L1pred list is first filled with the positive numbers from the UniqueList preferably in increasing order, followed by the negative numbers from the UniqueList, preferably in decreasing order. If we use the same example as above, then the entries of the current L1pred list are set equal to {3, 5, −1, −3, −6}.

Similar to VVC, the number of “active” pictures in each of L0pred and L1pred may be derived or signaled in the bitstream. For example, if the number of “active” pictures are set to 4 for both L0pred and L1pred in the example above we would end up with the following active entries in the current L0pred list {−1, −3, −6, 3} and the following active entries in the current L1pred list {3, 5, −1, −3}.

A decoder may perform the following steps according to this embodiment 5 to derive at least one entry in the current L0pred list:

1) Decode a flag from the set of syntax elements.

2) In response to the flag being equal to a predetermined value, setting the entry value in the current L0pred list to one of the values in UniqueList without decoding any other syntax element than the flag in order to determine which value in UniqueList to set the entry value to.

3) Optional additional step: Assuming N negative numbers in UniqueList, with N larger than 1 and the size of the current L0pred list equal to or larger than N, setting the N first entries of the current L0pred list equal to the first N entries of a sorted sequence of the N negative numbers; sorted in decreased order with the highest negative number first.

4) Optional additional step: Assuming M positive numbers in UniqueList, with M larger than 1, setting the M last entries of the current L0pred list equal to the first M entries of a sorted sequence of the M positive numbers; sorted in increased order with the lowest positive number first.

A decoder may perform the following steps according to this embodiment 5 to derive at least one entry in the current L1pred list:

1) Decode a flag from the set of syntax elements.

2) In response to the flag being equal to a predetermined value, setting the entry value in the current L1pred list to one of the values in UniqueList without decoding any other syntax element than the flag in order to determine which value in UniqueList to set the entry value to.

3) Optional additional step: Assuming N positive numbers in UniqueList, with N larger than 1 and the size of the current L1pred list equal to or larger than N, setting the N first entries of the current L1pred list equal to the first N entries of a sorted sequence of the N positive numbers; sorted in increased order with the lowest positive number first.

4) Optional additional step: Assuming M negative numbers in UniqueList, with M larger than 1, setting the M last entries of the current L1pred list equal to the first M entries of a sorted sequence of the M negative numbers; sorted in increased order with the lowest positive number first.

### Embodiment 6: Delta Coding of the L0 and L1 Lengths

In this embodiment 6, the number of entries in the current L0pred list is derived by decoding a first delta value from the set of syntax elements and adding the first delta value to a predicted number of L0pred entries. In a preferred version, this embodiment is combined with embodiment 1 and the predicted number of L0pred entries is equal to the number of L0pred entries of the entry i in the LOL, with entry i of the LOL being as described in embodiment 1.

Similarly, the number of entries in the current L1pred list is derived by decoding a second delta value from the set of syntax elements and adding the second delta value to a predicted number of L1pred entries. In a preferred version the predicted number of L1pred entries is equal to the number of L1pred entries of the entry i in the LOL, with entry i of the LOL being as described in embodiment 1.

The first and second delta values are preferably decoded from one syntax element each.

### Embodiment 7: Use of the LOL for Decoding a Picture

This embodiment 7 is an addition to at least embodiment 1 above and describes how the current L0pred list and the current L1pred list may be used to decode a current coded picture. The current L0pred list and current L1pred list may be constructed according to any previously described embodiment, and the process of decoding a current coded picture includes the following steps.

First, an index value v is decoded from one or more syntax elements of the current coded picture. The one or more syntax elements may be decoded from slice data of the current coded picture. In an implementation in a video codec environment similar to HEVC and VVC, this would mean that the syntax elements are CABAC-coded syntax elements.

The index value v is then used as an index to the current L0pred list to select an element of the current L0pred list. The value of that element is then used to identify a first reference picture. This first reference picture is then used in a motion compensation process in the process of decoding the current coded picture.

Optionally, an index value w is decoded from one or more syntax elements of the current coded picture. These one or more syntax elements may also be decoded from slice data of the current coded picture. The index value w is then used as an index to the current L1pred list to select an element of the current L1pred list. The value of that element is then used to identify a second reference picture. This second reference picture is then used in combination with the first reference picture in the motion compensation process in the process of decoding the current coded picture.

### Embodiment 8: Syntax Table and Pseudocode

An embodiment was implemented on top of the ECM-6.0 experimental video codec. The ECM-6.0 codec is built on top of VVC and uses the VVC handling of reference picture lists. The implementation added a number of syntax elements to the ECM-6.0 sequence parameter set as shown in Table 12 below where lines 4-28 are added. The syntax table format follows that of the VVC specification where syntax elements are shown in bold and have an associated type identifier in the “Descriptor” column, which type identifier shows the syntax element type. u(1) is a 1-bit flag, ue(v) is a UVLC codeword, se(v) is a signed UVLC codeword and u(v) is a codeword of length v, where the value of v is derived by the decoder.

TABLE 12

| | | Descriptor |
|---|---|---|
| 1 | seq_parameter_set_rbsp( ) { | |
| 2 | ... | |
| 3 | sps_{—}rpl1_{—}same_{—}as_{—}rpl0_{—}flag | u(1) |
| 4 | sps_{—}inter_{—}rpl_{—}flag | u(1) |
| 5 | if( sps_inter_rpl_flag ) { | |
| 6 | sps_{—}inter_{—}rpl_{—}num_{—}ref_{—}pic_{—}lists_{—}minus2 | ue(v) |
| 7 | for ( rplIdx = 0 ; rplIdx < sps_inter_rpl_num_ref_pic_lists_minus2+2 ; rplIdx ++ ) { | |
| 8 | if( rplIdx == 0 ) { | |
| 9 | for( i = 0; i < ( sps_rpl1_same_as_rpl0_flag ? 1 : 2 ); i++ ) { | |
| 10 | num_{—}ref_{—}entries[ i ] [ rplIdx ] | ue(v) |
| 11 | for ( j=0 ; j< numEntries[ i ] ; j++) { | |
| 12 | inter_{—}rpl_{—}entry_{—}abs_{—}delta_{—}poc[ i ][ rplIdx ][ j ] | ue(v) |
| 13 | if (strp_entry_abs_delta_poc > 0 ) | |
| 14 | inter_{—}rpl_{—}entry_{—}sign_{—}flag[ i ][ rplIdx ][ j ] | u(1) |
| 15 | } | |
| 16 | } | |
| 17 | } else { | |
| 18 | inter_{—}rpl_{—}abs_{—}delta_{—}poc_{—}minus1 | ue(v) |
| 19 | inter_{—}rpl_{—}sign_{—}flag | u(1) |
| 20 | for( i = 0; i < ( sps_rpl1_same_as_rpl0_flag ? 1 : 2 ); i++ ) { | |
| 21 | delta_{—}num_{—}ref_{—}entries[ i ] | se(v) |
| 22 | inter_{—}rpl_{—}use_{—}guessed_{—}list_{—}flag[ i ] | u(1) |
| 23 | if( ! inter_rpl_use_guessed_list_flag[ i ] ) | |
| 24 | for ( j=0 ; j< numEntries[ i ] ; j++) | |
| 25 | inter_{—}rpl_{—}idx[ i ][ j ] | u(v) |
| 26 | } | |
| 27 | } | |
| 28 | } | |
| 29 | } else { | |
| 30 | for( i = 0; i < ( sps_rpl1_same_as_rpl0_flag ? 1 : 2 ); i++ ) { | |
| 31 | sps_{—}num_{—}ref_{—}pic_{—}lists[ i ] | ue(v) |
| 32 | for( j = 0; j < sps_num_ref_pic_lists[ i ]; j++) | |
| 33 | ref_pic_list_struct( i, j ) | |
| 34 | } | |

Line 3 is a syntax element of ECM-6.0. It specifies whether the L1pred list is a copy of the L0pred list or specified separately. If L1pred is a copy, some L1pred syntax is not present in the bitstream.

The sps_inter_rpl_flag on line 4 is a 1-bit flag that specifies whether the proposed method is used or not. If equal to 0, lines 29-32 directly follows and those are part of the existing ECM-6.0 syntax. If the flag is equal to 1, the sps_inter_rpl_num_ref_pic_lists_minus2 syntax element follows. It specifies the number of entries in the LOL minus 2. The syntax element is UVLC coded and the constant 2 is added which means that the lowest expressible size of the LOL is 2. For list sizes of 0 or 1, sps_inter_rpl_flag must be equal to 0. Thereafter, on line 7, there is a loop over the number of entries in the LOL.

Lines 9-16 are applied for the first entry. These lines are duplicates of existing ECM-6.0 syntax inside the ref_pic_list_struct(i, j) syntax structure, not shown. These syntax elements are also part of the ref_pic_list_struct(listIdx, rplsIdx) syntax structure in the VVC standard specification where num_ref_entries[i][rplIdx] in the table corresponds to num_ref_entries[listIdx][rplsIdx] in VVC, inter_rpl_entry_abs_delta_poc[i][rplIdx][j] corresponds to abs_delta_poc_st[listIdx][rplsIdx][i], and inter_rpl_entry_sign_flag[i][rplIdx] [j] corresponds to strp_entry_sign_flag[listIdx][rplsIdx][i]. In short, lines 9-16 specifies the L0pred and L1pred lists for the first entry in the LOL without use of any of the proposed prediction method.

Lines 17-27 are applied for the remaining entries in the LOL. The syntax elements on lines 18 and 19 specifies the delta POC value to be used in the method. Line 20 specifies whether there is syntax for L1pred or not and the delta_num_ref_entries[i] syntax element on line 21 carries a delta size value. The size of the current L0pred list is set equal to this delta size value plus the size of the L0pred list for the previous entry in LOL. The flag on line 22 specifies whether the current L0pred or L1pred list is using its guessed list. If not, the L0pred or L1pred list is constructed using the value of the syntax element on line 25 for each entry. This syntax element provides an index value to UniqueList that holds the value to use.

Table 13 below shows exemplary pseudo-code of the implementation as implemented on-top of ECM-6.0:

```
TABLE 13
void HLSyntaxReader::parseRefPicListInterRPL(SPS* sps)
{
  const int* POC = NULL;
  int lx;
  uint32_t numEntriesLX[2];
  uint32_t prevNumEntriesLX[2] = { 0,0 };
  uint32_t useGuessedList[2];
  uint32_t code;
  int Value;
  int DeltapocRPL;
  std::vector<int> UniqueList;
  // Read 1 bit from the bitstream and assign variable code to the value
  READ_CODE(1, code, “sps_inter_rpl_flag”);
  if (code == 0)
    return;
  // Read a UVLC codeword from the bitstream and set the variable code to
  // its value
  READ_UVLC(code, “sps_inter_rpl_num_ref_pic_lists_minus2”);
  int numberOfRPL = code + 2;
  for (int rplIdx = 0; rplIdx < numberOfRPL; rplIdx++)
  {
    // Let rplLX[0] point to the L0pred list and rplLX[1] point to L1pred
    ReferencePictureList* rplLx[2];
    rplLX[0] = sps−>getRPLList0( )−>getReferencePictureList(rplIdx);
    rplLX[1] = sps−>getRPLList1( )−>getReferencePictureList(rplIdx);
    if (rplIdx == 0)
    {
      // For the first entry, decode L0pred and L1pred using the current
      // ECM method
      for (lx = 0; lx < (sps−>getRPL1CopyFromRPL0Flag( ) ? 1 : 2); lx++)
      {
        int deltaValue = 0;
        READ_UVLC(numEntriesLX[lx], “num_ref_entries_lx”);
        for (int ii = 0; ii < numEntriesLX[lx]; ii++)
        {
          READ_UVLC(code, “inter_rpl_entry_abs_delta_poc[Lx][rplIdx][i]”);
          Value = (ii == 0) ? code + 1 : code;
          if (Value > 0)
          {
            READ_FLAG(code, “inter_rpl_entry_sign_flag[Lx][rplIdx][i]”);
            deltaValue = (code) ? deltaValue − Value : deltaValue + Value;
          }
          rplLX[lx]−>setRefPicIdentifier(ii, deltaValue, 0, false, 0);
        }
      }
    }
    else
    {
      // Derive delta POC between current and previous entry
      READ_UVLC(code, “inter_rpl_abs_delta_poc_minus1”);
      DeltapocRPL = code + 1;
      READ_FLAG(code, “inter_rpl_sign_flag”);
      if (code)
        DeltapocRPL = −DeltapocRPL;
      // Update UniqueList by recalculating POC offsets using the delta POC
      for (int i = 0; i < UniqueList.size( ); i++)
        UniqueList[i] += DeltapocRPL;
      // Add the POC of the current picture and sort
      UniqueList.push_back(DeltapocRPL);
      sort(UniqueList.begin( ), UniqueList.end( ));
      const int SizeUniqueList = (int)UniqueList.size( );
      // Decode number of L0 and L1 entries
      useGuessedList[1] = 0;
      for (lx = 0; lx < (sps−>getRPL1CopyFromRPL0Flag( ) ? 1 : 2); lx++)
      {
        // Read a signed UVLC from the bitstream and set the variable Value
        // to its value
        READ_SVLC(Value, “delta_num_ref_entries_lx”);
        numEntriesLX[lx] = numEntriesLX[1] = prevNumEntriesLX[lx] + Value;
        // Decode guessed list flag and decode indices to Uniquelist if
        // flag is 0
        READ_FLAG(useGuessedList[lx],
“inter_rpl_use_guessed_list_flag_lx”);
        if (!useGuessedList[lx])
        {
          for (int ii = 0; ii < numEntriesLX[lx]; ii++)
          {
            READ_CODE(ceilLog2(SizeUniqueList), code, “inter_rpl_idx_lx”);
            rplLX[lx]−>setRefPicIdentifier(ii, UniqueList[code], 0, false,
0);
          }
        }
      }
      // Set indexToFirstPositiveEntry to the index of the 1st positive
      // entry in UniqueList
      int indexToFirstPositiveEntry;
      for (indexToFirstPositiveEntry = 0;
  indexToFirstPositiveEntry < SizeUniqueList &&
UniqueList[indexToFirstPositiveEntry] < 0;
            indexToFirstPositiveEntry++);
      // If signalled, set L0 to its guessed list
      if (useGuessedList[0])
      {
        for (int ii = 0; ii < numEntriesLX[0]; ii++)
        {
          int index = indexToFirstPositiveEntry − ii − 1;
          if (index < 0)
            index = ii % SizeUniqueList;
          rplLX[0]−>setRefPicIdentifier(ii, UniqueList[index], 0, false,
0);
        }
      }
      // If signalled, set L1 to its guessed list
      if (useGuessedList[1])
      {
        for (int ii = 0; ii < numEntriesLX[1]; ii++)
        {
          int index = indexToFirstPositiveEntry + ii;
          if (index >= SizeUniqueList)
            index = SizeUniqueList − (ii % SizeUniqueList) − 1;
          rplLX[1]−>setRefPicIdentifier(ii, UniqueList[index], 0, false,
0);
        }
      }
    }
    if (sps−>getRPL1CopyFromRPL0Flag( ))
    {
      numEntriesLX[1] = numEntriesLX[0];
      for (int ii = 0; ii < numEntriesLX[1]; ii++)
        rplLX[1]−>setRefPicIdentifier(ii, rplLx[0]−
>getRefPicIdentifier(ii), 0, false, 0);
    }
    for (lx = 0; lx < 2; lx++)
      prevNumEntriesLX[lx] = numEntriesLX[lx];
    // Construct UniqueList for the next picture, add L0 and L1 entries
    // without duplicates
    UniqueList.resize(0);
    for (lx = 0; lx < 2; lx++)
    {
      for (int ii = 0; ii < numEntriesLX[lx]; ii++)
      {
        int poc_rpl = rplLX[lx]−>getRefPicIdentifier(ii);
        if (std::find(UniqueList.begin( ), UniqueList.end( ), poc_rpl) ==
UniqueList.end( ))
          UniqueList.push_back(poc_rpl);
      }
    }
  }
}
```

Let's walk through the code using an example where the first two entries in the LOL are as shown in FIG. 5 as follows:

First entry (rplIdx==0): L0pred={−32, −64, −48, −40, −36} L1pred={−32, −48}.

Second entry (rplIdx==1): L0pred={−16, −32, −48, −24, −20} L1pred={16}.

The decoder first decodes sps_inter_rpl_flag equal to 1 followed by sps_inter_rpl_num_ref_pic_lists_minus2. Let's assume there are 32 entries so this value is equal to 30 which makes numberOfRPL equal to 32. sps->getRPL1CopyFromRPLOFlag( ) is equal to 0 throughout since L0pred and L1pred are not identical.

For the first entry (rplIdx==0), num_ref_entries_lx is decoded as equal to 5 followed by the following decoded syntax elements and values:
inter_rpl_entry_abs_delta_poc[Lx][rplIdx][i] 31
inter_rpl_entry_sign_flag[Lx][rplIdx][i] 1
inter_rpl_entry_abs_delta_poc[Lx][rplIdx][i] 32
inter_rpl_entry_sign_flag[Lx][rplIdx][i] 1
inter_rpl_entry_abs_delta_poc[Lx][rplIdx][i] 16
inter_rpl_entry_sign_flag[Lx][rplIdx][i] 0
inter_rpl_entry_abs_delta_poc[Lx][rplIdx][i] 8
inter_rpl_entry_sign_flag[Lx][rplIdx][i] 0
inter_rpl_entry_abs_delta_poc[Lx][rplIdx][i] 4
inter_rpl_entry_sign_flag[Lx][rplIdx][i] 0.

This gives an L0pred equal to {−32, −64, −48, −40, −36} where each value is stored in the list of list by the statement rplLX[lx]->setRefPicIdentifier(ii, delta Value, 0, false, 0);

Similarly, L1pred equal to {−32, −48} is decoded by the following sequence of syntax elements:
num_ref_entries_lx 2
inter_rpl_entry_abs_delta_poc[Lx][rplIdx][i] 31
inter_rpl_entry_sign_flag[Lx][rplIdx][i] 1
inter_rpl_entry_abs_delta_poc[Lx][rplIdx][i] 16
inter_rpl_entry_sign_flag[Lx][rplIdx][i] 1

After this, prevNumEntriesLX[0] and prevNumEntriesLX[1] is set to 5 and 2 respectively followed by construction of UniqueList. It is first set to the empty list. Thereafter, each element in L0pred and L1pred is added to UniqueList, conditioned on that the element is not already present in UniqueList.

This results in the UniqueList being equal to {−32, −64, −48, −40, −36}. All elements from L0pred are added, but no element from L1pred is then added since both of the values in L1pred already exist in UniqueList.

Thereafter the for loop continues with rplIdx equal to 1.

First, DeltapocRPL is set equal to 16 by decoding these two syntax elements:
inter_rpl_abs_delta_poc_minus1 15
inter_rpl_sign_flag 0

Then 16 is added to each of the elements in UniqueList followed by adding 16 itself followed by sorting, which results in UniqueList being equal to {−48, −32, −24, −20, −16, 16}. SizeUniqueList is set equal to 6.

Next, delta_num_ref_entries_lx is decoded as equal to 0, then setting numEntriesLX[0] equal to 5. Without delta coding of the size, the value 5 would have had to be sent, which would have cost more bits.

inter_rpl_use_guessed_list_flag_lx is next decoded as equal to 0, specifying that the guessed list is not used by L0pred. Since numEntriesLX[0] is equal to 5, the following syntax elements are decoded, each coded by 3 bits:
inter_rpl_idx_lx 4
inter_rpl_idx_lx 1
inter_rpl_idx_lx 0
inter_rpl_idx_lx 2
inter_rpl_idx_lx 3.

L0pred is therefore decoded to be equal to {−16, −32, −48, −24, −20}.

For L1pred, delta_num_ref_entries_lx is decoded as equal to −1, then setting numEntriesLX[1] equal to 1. inter_rpl_use_guessed_list_flag_lx is decoded to 1, specifying that the guessed list is used by L1pred.

The for loop sets indexToFirstPositiveEntry equal to 5, and UniqueList[5] is indeed the first positive entry, and therefore the lowest positive value in UniqueList. The variable index is set equal to 5 and since UniqueList[5] is equal to 16, L1pred is set equal to {16}

Finally, prevNumEntriesLX is updated for the next iteration of rplIdx and UniqueList is constructed. It is first set to the empty list. Thereafter, each element in L0pred and L1pred is added to UniqueList, conditioned on that the element is not already present in UniqueList. There are no duplicates this time, so UniqueList is set equal to {−16, −32, −48, −24, −20, 16}.

In an additional embodiment, the method is used with pictures in the bitstreams being coded using a hierarchical B-picture prediction structure, where the number of pictures in-between anchor pictures is equal to 2\hat{ }N−1. This means that after an anchor picture is decoded from the bitstream, there are 2\hat{ }N−1 pictures immediately following the anchor pictures in the bitstream that are arranged in a hierarchical B-picture prediction structure and are output before the anchor picture is output. We here say that the sub-GOP size of the B-picture prediction structure is equal to N. In this embodiment, the deltaPOC value is derived as follows. A first value F is decoded from a single syntax element in the set of syntax elements, wherein the first value represents a sub-GOP size equal to 2\hat{ }F. Then the deltaPOC value is derived from the value F and j, wherein j is the index in LOL comprising the current L0pred list and the current L1pred list. The value F is decoded once and used for deriving 2\hat{ }N entries in the LOL, each entry corresponding to one picture position in the sub-GOP. This means that instead of decoding 2\hat{ }N syntax elements, one for each deltaPOC value, there is only one value F to decode which defines a sequence of deltaPOC values to use for the 2\hat{ }N entries. In one variant, a list DELTA is derived from the value F and the deltaPOC value to use for the current L0pred list and the current L1pred list is equal to DELTA[j], where j is the index in LOL comprising the current L0pred list and the current L1pred list.

### Additional Disclosure

This disclosure further proposes to add prediction to the signaling of the RPLs in the SPS. The method utilizes that the L0 and L1 picture references of an entry in the SPS list of RPLs is limited to the L0 and L1 picture references of the previous entry plus the previous picture. The slice data and therefore also all decoded sample values is asserted to be unaffected by the method.

The HEVC specification includes reference picture sets (RPSs) that are used both for DPB management and signaling of reference picture lists L0 and L1. An HEVC SPS may contain a list of RPSs, and such an RPS can be referred to by a slice header. The HEVC slice header then include a syntax element short_term_ref_pic_set_idx that specifies which entry in the SPS list of RPSs to use for the current slice.

The RPS signaling in HEVC includes a mechanism for predicting an entry in the list of RPSs from another, previously signaled, entry. This prediction is enabled when the inter_ref_pic_set_prediction_flag in HEVC is equal to 1.

The VVC specification uses reference picture lists (RPLs) rather than RPSs. The RPLs in VVC are similar to RPSs, signals L0 and L1 lists more directly. As in HEVC The RPLs can be signaled in the SPS with a syntax element rpl_idx[i] in the picture header or slice header to specifies which one to use for a picture. VVC does not include prediction of RPLs as HEVC does for RPSs.

ECM has inherited the RPL method from VVC and uses a very similar syntax as shown in Table 14 and Table 15.

TABLE 14
VVC syntax elements and corresponding ECM-6.0 SPS decoding code

| VVC SPS syntax element | ECM-6.0 SPS decoding code |
|---|---|
| sps_rpl1_same_as_rpl0_flag | READ_FLAG(uiCode, “rpl1_copy_from_rpl0_flag”); |
| sps_num_ref_pic_lists[i] | READ_UVLC(uiCode, “num_ref_pic_lists_in_sps[0]”); |
| | READ_UVLC(uiCode, “num_ref_pic_lists_in_sps[1]”); |
| num_ref_entries[listIdx][rplsIdx] | READ_UVLC(code, “num_ref_entries[listIdx][rplsIdx]”); |
| abs_delta_poc_st[listIdx][rplsIdx][i] | READ_UVLC(code, “abs_delta_poc_st[listIdx][rplsIdx][i]”); |
| strp_entry_sign_flag[listIdx][rplsIdx][i] | READ_FLAG(code, “strp_entry_sign_flag[listIdx][rplsIdx][i]”); |

TABLE 15
VVC syntax elements and corresponding ECM-6.0 picture header decoding code

| VVC VCL syntax element | ECM-6.0 picture header decoding code |
|---|---|
| rpl_sps_flag[i] | READ_FLAG(uiCode, “ref_pic_list_sps_flag[0]”); |
| rpl_idx[i] | READ_CODE(numBits, uiCode, “ref_pic_list_idx[0]”); |

This disclosure proposes to add prediction to the signaling of the RPLs in the SPS. The method utilizes that the L0 and L1 picture references of an entry in the SPS list of RPLs is limited to the L0 and L1 picture references of the previous entry plus the previous picture.

Let RplList be the list of RPLs in the SPS and let RPL be the entry in RplList containing an L0 and L1 list.

This disclosure proposes adding prediction to the signaling of the RplList. For a current RPL, the decoder will maintain a list of picture references used by the previously signaled RPL, add the previous picture to this list, and use decoded index values in this list to construct the L0 and L1 lists for the current RPL. Simplified, the syntax for prediction looks as shown in Table 16.

TABLE 16
Conceptual RPL prediction syntax

| | |
|---|---|
| seq_parameter_set_rbsp( ) { | |
| ... | |
| sps_{—}inter_{—}rpl_{—}num_{—}ref_{—}pic_{—}lists | ue(v) |
| for ( rplIdx = 1 ; rplIdx < sps_inter_rpl_num_ref_pic_lists ; rplIdx ++ ) { | |
| for( lx = 0; lx < 2 ; lx++ ) { | |
| sps_{—}num_{—}ref_{—}entries[ lx ] | se(v) |
| for ( j=0 ; j< num_ref_entries[ lx ] ; j++) | |
| sps_{—}inter_{—}rpl_{—}idx[ lx ][ rplIdx ][ j ] | u(v) |
| } | |

sps_inter_rpl_num_ref_pic_lists is the number of RPLs in RplList.

sps_num_ref_entries[lx] is the number of entries for LX (L0 or L1).

sps_inter_rpl_idx[lx][rplIdx][j] is the index to the list of picture references identifying the value for LX[j] in the rplIdx'th entry of RplList.

In addition, it is proposed that: 1) one L0 flag and one L1 flag for each RPL is added to ECM. Each flag specifies whether automatically generated L0 and L1 lists will be used. If so, the corresponding sps_inter_rpl_idx[lx][rplIdx][j] syntax elements are not present; 2) signaling the log 2 of the GOP size is added, which may be used to derive POC delta values between RPL entries that are needed to maintain the list of picture references; and 3) Delta coding of sps_num_ref_entries[lx] is used.

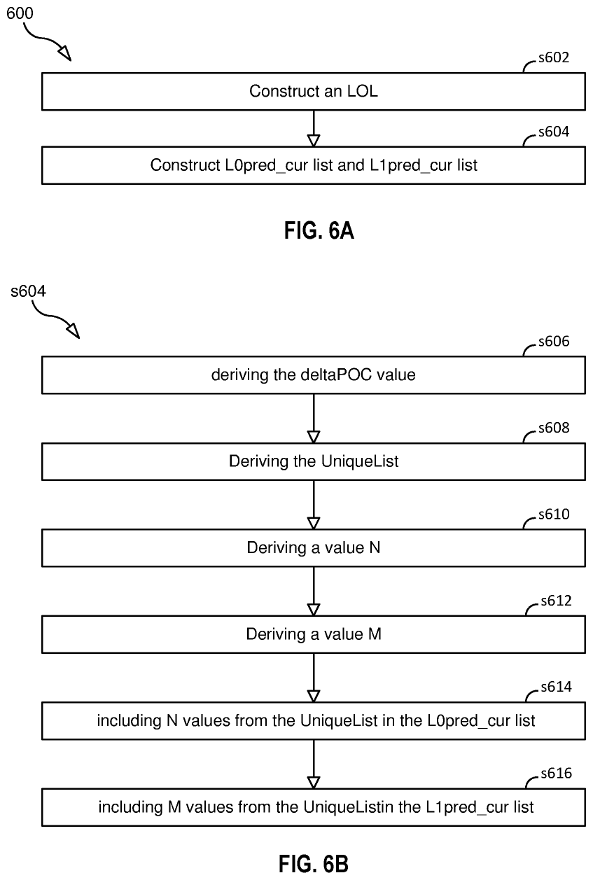

FIG. 6A is a flowchart illustrating a process 600 for decoding a video bitstream. Process 600 may begin in step s602. Step s602 comprises constructing an LOL before any coded picture that references the LOL is decoded. The LOL comprises an entry comprising i) a first previous reference picture list, the L0pred_prev list, and ii) a second previous reference picture list, the L1pred_prev list, wherein the L0pred_prev list comprises a first set of values (as used herein a “set of values” may contain a single value and also may contain duplicate values, hence each of {1}, {1, 2, 3} and {1, 2, 3, 1} is an example of a “set of values.”) and the L1pred_prev list comprises a second set of values, and further wherein each value included in the first set of values and the second set of values represents a reference picture indicator that can be used in the decoding process of a coded picture. Step s604 comprises constructing a first current reference picture list, the L0pred_cur list, and a second current reference picture list, the L1pred_cur list, based on the L0pred_prev list and the L1pred_prev list.

FIG. 6B illustrates the steps that comprise step s604 in some embodiments. As shown in FIG. 6B, step s604 includes steps s606 to s616. Step s606 comprises deriving a value, the deltaPOC value, from a set of syntax elements in the bitstream. Step s608 comprises deriving a set of values, the UniqueList, wherein the UniqueList comprises a) the deltaPOC value and b) a third set of values, wherein each value in the third set of values is equal to either i) the sum of a value from the first set of values and the deltaPOC value or ii) the sum of a value from the second set of values and the deltaPOC value (in one embodiment, other than the deltaPOC value, there is no value within the UniqueList that is not either i) equal to the sum of a value from the first set of values and the deltaPOC value or ii) equal to the sum of a value from the second set of values and the deltaPOC value). Note that L0pred_prev list and L1Pred_prev list may contain duplicates, but there are no duplicates within UniqueList. Step s610 comprises deriving a value N (e.g. N may be derived from the set of syntax elements). Step s612 comprises deriving a value M (e.g. M may be derived from the set of syntax elements). Step s614 comprises including N values from the UniqueList in the L0pred_cur list. Step s616 comprises including M values from the UniqueList in the L1pred_cur list.

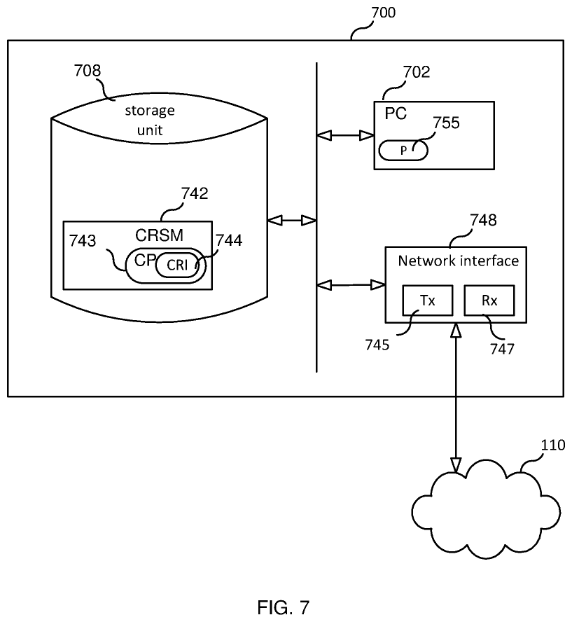

FIG. 7 is a block diagram of an apparatus 700 for implementing encoder 102 and/or decoder 104, according to some embodiments. When apparatus 700 implements encoder 102, apparatus 700 may be referred to as an encoder apparatus, and when apparatus 700 implements decoder 104, apparatus 700 may be referred to as a decoder apparatus. As shown in FIG. 7, apparatus 700 may comprise: processing circuitry (PC) 702, which may include one or more processors (P) 755 (e.g., one or more general purpose microprocessors and/or one or more other processors, such as an application specific integrated circuit (ASIC), field-programmable gate arrays (FPGAs), and the like), which processors may be co-located in a single housing or in a single data center or may be geographically distributed (i.e., encoder apparatus 700 may be a distributed computing apparatus); at least one network interface 748 (e.g., a physical interface or air interface) comprising a transmitter (Tx) 745 and a receiver (Rx) 747 for enabling apparatus 700 to transmit data to and receive data from other nodes connected to a network 110 (e.g., an Internet Protocol (IP) network) to which network interface 748 is connected (physically or wirelessly) (e.g., network interface 748 may be coupled to an antenna arrangement comprising one or more antennas for enabling encoder apparatus 700 to wirelessly transmit/receive data); and a storage unit (a.k.a., “data storage system”) 708, which may include one or more non-volatile storage devices and/or one or more volatile storage devices. In embodiments where PC 702 includes a programmable processor, a computer readable storage medium (CRSM) 742 may be provided. CRSM 742 may store a computer program (CP) 743 comprising computer readable instructions (CRI) 744. CRSM 742 may be a non-transitory computer readable medium, such as, magnetic media (e.g., a hard disk), optical media, memory devices (e.g., random access memory, flash memory), and the like. In some embodiments, the CRI 744 of computer program 743 is configured such that when executed by PC 702, the CRI causes encoder apparatus 700 to perform steps described herein (e.g., steps described herein with reference to the flow charts). In other embodiments, encoder apparatus 700 may be configured to perform steps described herein without the need for code. That is, for example, PC 702 may consist merely of one or more ASICs. Hence, the features of the embodiments described herein may be implemented in hardware and/or software.

### Summary of Various Embodiments

A1. A method (600) for decoding a video bitstream, the method comprising:
constructing a list of lists, LOL, before any coded picture that references the LOL is decoded, the LOL comprising an entry comprising i) a first previous reference picture list, the L0pred_prev list, and ii) a second previous reference picture list, the L1pred_prev list, wherein the L0pred_prev list comprises a first set of values and the L1pred_prev list comprises a second set of values, and further wherein each value included in the first set of values and the second set of values represents a reference picture indicator that can be used in the decoding process of a coded picture; and
constructing a first current reference picture list, the L0pred_cur list, and a second current reference picture list, the L1pred_cur list, based on the L0pred_prev list and the L1pred_prev list, wherein constructing the L0pred_cur list and L1pred_cur list comprises:
deriving a value, the deltaPOC value, from a set of syntax elements in the bitstream;
deriving a set of values, the UniqueList, wherein the UniqueList comprises a) the deltaPOC value and b) a third set of values, wherein each value in the third set of values is equal to either i) the sum of a value from the first set of values and the deltaPOC value or ii) the sum of a value from the second set of values and the deltaPOC value;
deriving a value N (e.g. N may be derived from the set of syntax elements);
deriving a value M (e.g. M may be derived from the set of syntax elements);
including N values from the UniqueList in the L0pred_cur list; and
including M values from the UniqueList in the L1pred_cur list.

A2. The method of embodiment A1, further comprising using the L0pred_cur list and the L1pred_cur list in a process for decoding a current coded picture from the video bitstream.

A3. The method of embodiment A1 or A2, wherein
the L0pred_cur list is included in an entry of the LOL, and
the L1pred_cur list is also included in the entry of the LOL.

A4. The method of any one of embodiments A1-A3, wherein the set of syntax elements are parameter set syntax elements.

A5. The method of any one of embodiments A1-A3, wherein the set of syntax elements is one of, or a combination of, video coding layer, VCL syntax elements, slice header syntax elements, or picture header syntax elements.

A6. The method of any one of embodiments A1-A5, further comprising:
decoding an index value from a syntax element in the set of syntax elements, wherein the index value identifies said entry of the LOL that contains the L0pred_prev and L1Pred_prev lists; and
prior to constructing the L0pred_cur and L1pred_cur lists based on the L0pred_prev list and the L1pred_prev list, using the decoded index value to select said entry of the LOL.

A7. The method of any one of embodiments A1-A6, wherein including the N values from the UniqueList in the L0pred_cur list comprises:
deriving an index value, j, from the set of syntax elements; and
including in the L0pred_cur list the value from the entry of the UniqueList associated with the index value, j.

A7.5. The method of any one of embodiments A1-A6, wherein including the N values from the UniqueList in the L0pred_cur list comprises:
for each entry in the L0pred_cur list, deriving an index value, j, from the set of syntax elements and storing in said entry of the L0pred_cur list the j'th value in the UniqueList (e.g., UniqueList[j] where the UniqueList is implemented as an array of values).

A8. The method of embodiment A7 or A7.5, wherein deriving j comprises:
determining the size of the UniqueList;
determining a number of bits, M, based on the determined size, wherein M=ceil(log 2(S)), where S is the determined size; and
decoding an M bit syntax, wherein Vis the value of the decoded M bit syntax element; and
setting j equal to V or equal to V+1.

A9. The method of any one of embodiments A1-A6, wherein including the N values from the UniqueList in the L0pred_cur list comprises:
decoding a flag from the set of syntax elements; and
in response to determining that the flag is equal to a predetermined value, including the N values in UniqueList in the L0pred_cur list without decoding any syntax element that specifies which of the N values in UniqueList to add to the L0pred_cur list (and, in some embodiments, without decoding any syntax element specifying in what order to add the N values).

A10. The method of embodiment A9 wherein,
the UniqueList comprises N negative numbers, where N>1, and
the N values from the UniqueList that are added to the L0pred_cur list are said N negative numbers.

A11. The method of embodiment A10, wherein
the N negative numbers comprise a first negative number, N1, and a second negative number, N2, wherein N1>N2,
the L0pred_cur list is data structure (e.g., an array, a linked list, etc.) comprising a first element followed by a second element, and
including the N values from the UniqueList in the L0pred_cur list comprises:
i) setting the value of the first element of the data structure to N1; and
ii) setting the value of the second element of the data structure to N2.

A12. The method of embodiment A10, wherein including the N negative numbers from the UniqueList in the L0pred_cur list comprises setting the N first entries of the L0pred_cur list equal to the first N entries of a sorted sequence of the N negative numbers, sorted in decreased order with the highest negative number first.

A13. The method of any one of embodiments A1-A12, wherein
the L0pred_prev list consists of P entries; and
deriving N comprises:
i) deriving a delta value, D, from the set of syntax elements; and
ii) setting N equal to D+P.

A14 The method of any one of embodiments A2-A13, further comprising:
deriving a second index value, W, from on one of, or a combination of, video coding layer, VCL syntax elements, slice header syntax elements, or picture header data; and
using the second index value W to select an entry from the LOL, wherein the selected entry comprises L0pred_cur and L1pred_cur.

A15. The method of any one of embodiments A1-A14, further comprising:
deriving a first index value, V, from one or more first syntax elements of a coded picture;
using the V to select a value from the L0pred_cur list;
using the selected value to identify a reference picture; and
using the identified reference picture in a motion compensation process for decoding the coded picture.

A16. The method of embodiment A15, wherein the one or more first syntax elements are positioned in coded slice data of the coded picture.

A17. The method of any one of embodiments A1-A16, wherein deriving the deltaPOC value from a set of syntax elements in the bitstream comprises:
decoding a first value N representing a sub-GOP size from the set of syntax elements wherein the sub-GOP size is equal to 2\hat{ }N; and
deriving the deltaPOC value from the value N and a value J, wherein J is the index in the LOL comprising the current L0pred list and the current L1pred list.

A18. The method of any one of embodiments A1-A17, wherein including in the L1pred_cur list the N values from the UniqueList comprises:
deriving an index value, j, from the set of syntax elements; and
including in the L1pred_cur list the value from the entry of the UniqueList associated with the index value, j.

A19. The method of any one of embodiments A1-A18, wherein deriving the UniqueList comprises:
obtaining an initial set of values, wherein the initial set of values consists of the union of a third set of values and a fourth set of values, wherein the third set of values is equal to the first of values with all duplicates removed and the fourth set of values is equal to the second set of values with all duplicates removed;
for each value included in the initial set of values, adding the deltaPOC value to the value included in the initial set of values, thereby producing an intermediate set of values; and
adding to the intermediate set of values the deltaPOC value, thereby producing the UniqueList (a.k.a., the “final UniqueList”).

A20. The method of any one of embodiments A1-A18, wherein deriving the UniqueList comprises:
obtaining an initial set of values, wherein the initial set of values consists of i) the union of a third set of values and a fourth set of values and ii) a value equal to 0, wherein the third set of values is equal to the first of values with all duplicates removed and the fourth set of values is equal to the second set of values with all duplicates removed;
for each value included in the initial set of values, adding the deltaPOC value to the value included in the initial set of values, thereby producing the UniqueList.

A21. The method of any one of embodiments A1-A20, wherein any of the L0pred_cur list, the L1pred_cur list, the L0pred_prev list, and the L1pred_prev list may contain duplicates, but there are no duplicates within UniqueList.

B1. A computer program (743) comprising instructions (744) which when executed by processing circuitry (702) of an apparatus (700) causes the apparatus to perform the method of any one of the above embodiments.

B2. A carrier containing the computer program of embodiment B1, wherein the carrier is one of an electronic signal, an optical signal, a radio signal, and a computer readable storage medium (742).

C1. A decoder apparatus (700) configured to perform the method of any one of embodiments A1-A21.

### Results and Conclusion

The described embodiments provide video compression bit-rate savings. The pseudo-code disclosed herein was implemented on top of the ECM-6.0 experimental video codec and tested according to the testing procedures specified by MPEG and ITU-T in document JVET-Y2017, jvet-experts(dot)org/doc_end_user/current_document.php?id=11473. On the so-called Class D test set, the method provides bit-rate savings between 0.09% and 1.18% compared to ECM-6.0 as-is, as shown in table 17 below. The average bit-rate savings for each of the four sequences is between 0.28% and 0.49%.

TABLE 17

| | | | BD-rate (cubic) | |
|---|---|---|---|---|
| QPISlice | | | Y | |
| Class D | BasketballPass | 22 | −0.28% | −0.09% |
| WQVGA | | 27 | | −0.18% |
| | | 32 | | −0.36% |
| | | 37 | | −0.69% |
| | BQSquare | 22 | −0.49% | −0.12% |
| | | 27 | | −0.30% |
| | | 32 | | −0.64% |
| | | 37 | | −1.18% |
| | BlowingBubbles | 22 | −0.31% | −0.09% |
| | | 27 | | −0.18% |
| | | 32 | | −0.37% |
| | | 37 | | −0.77% |
| | RaceHorses | 22 | −0.44% | −0.14% |
| | | 27 | | −0.27% |
| | | 32 | | −0.55% |
| | | 37 | | −1.08% |

Because the embodiments are implemented on the sequence-level rather than picture-level in a video codec, the computational complexity that the embodiments add is very small. Therefore, the embodiments provide a good compression/complexity trade-off.

While the terminology in this disclosure is described in terms of VVC, the embodiments of this disclosure also apply to any existing or future codec, which may use a different, but equivalent terminology.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method for decoding a video bitstream, the method comprising:
constructing a list of lists (LOL) before any coded picture that references the LOL is decoded, the LOL comprising an entry comprising i) a first previous reference picture list, the L0pred_prev list, and ii) a second previous reference picture list, the L1pred_prev list, wherein the L0pred_prev list comprises a first set of values and the L1pred_prev list comprises a second set of values, and further wherein each value included in the first set of values and the second set of values represents a reference picture indicator that can be used in the decoding process of a coded picture; and
constructing a first current reference picture list, the L0pred_cur list, and a second current reference picture list, the L1pred_cur list, based on the L0pred_prev list and the L1pred_prev list, wherein constructing the L0pred_cur list and L1pred_cur list comprises:
deriving a value, the deltaPOC value, from a set of syntax elements in the bitstream;
deriving a set of values, the UniqueList, wherein the UniqueList comprises a) the deltaPOC value and b) a third set of values, wherein each value in the third set of values is equal to either i) the sum of a value from the first set of values and the deltaPOC value or ii) the sum of a value from the second set of values and the deltaPOC value;
deriving a value N from the set of syntax elements;
deriving a value M from the set of syntax elements;
including N values from the UniqueList in the L0pred_cur list; and
including M values from the UniqueList in the L1pred_cur list.

2. The method of claim 1, wherein the method further comprises using the L0pred_cur list and the L1pred_cur list in a process for decoding a current coded picture from the video bitstream.

3. The method of claim 1, wherein
the L0pred_cur list is included in an entry of the LOL, and
the L1pred_cur list is also included in the entry of the LOL.

4. (canceled)

5. The method of claim 1, wherein the set of syntax elements is one of, or a combination of, video coding layer, VCL syntax elements, slice header syntax elements, or picture header syntax elements.

6. The method of claim 1, further comprising:
decoding an index value from a syntax element in the set of syntax elements, wherein the index value identifies said entry of the LOL that contains the L0pred_prev and L1Pred_prev lists; and
prior to constructing the L0pred_cur and L1pred_cur lists based on the L0pred_prev list and the L1pred_prev list, using the decoded index value to select said entry of the LOL.

7. The method of claim 1, wherein including the N values from the UniqueList in the L0pred_cur list comprises:
deriving an index value, j, from the set of syntax elements; and
including in the L0pred_cur list the value from the entry of the UniqueList associated with the index value, j.

8. The method of claim 1, wherein including the N values from the UniqueList in the L0pred_cur list comprises:
for each entry in the L0pred_cur list, deriving an index value, j, from the set of syntax elements and storing in said entry of the L0pred_cur list the j'th value in the UniqueList.

9. The method of claim 7, wherein deriving j comprises:
determining the size of the UniqueList;
determining a number of bits, M1, based on the determined size, wherein M1=ceil(log 2(S)), where S is the determined size; and
decoding an M1 bit syntax, wherein V is the value of the decoded M1 bit syntax element; and
setting j equal to V or equal to V+1.

10. The method of claim 1, wherein including the N values from the UniqueList in the L0pred_cur list comprises:
decoding a flag from the set of syntax elements; and
in response to determining that the flag is equal to a predetermined value, including the N values in UniqueList in the L0pred_cur list without decoding any syntax element that specifies which of the N values in UniqueList to add to the L0pred_cur list.

11. (canceled)

12. The method of claim 10, wherein
the UniqueList comprises N negative numbers, where N>1,
the N values from the UniqueList that are added to the L0pred_cur list are said N negative numbers,
the N negative numbers comprise a first negative number, N1, and a second negative number, N2, wherein N1>N2,
the L0pred_cur list is data structure comprising a first element followed by a second element, and
including the N values from the UniqueList in the L0pred_cur list comprises:
i) setting the value of the first element of the data structure to N1; and
ii) setting the value of the second element of the data structure to N2.

13. The method of claim 10, wherein
the UniqueList comprises N negative numbers, where N>1,
the N values from the UniqueList that are added to the L0pred_cur list are said N negative numbers, and
including the N negative numbers from the UniqueList in the L0pred_cur list comprises setting the N first entries of the L0pred_cur list equal to the first N entries of a sorted sequence of the N negative numbers, sorted in decreased order with the highest negative number first.

14. The method of claim 1, wherein
the L0pred_prev list consists of P entries; and
deriving N comprises:
i) deriving a delta value, D, from the set of syntax elements; and
ii) setting N equal to D+P.

15. The method of claim 2, further comprising:
deriving a second index value, W, from on one of, or a combination of, video coding layer, VCL syntax elements, slice header syntax elements, or picture header data; and
using the second index value W to select an entry from the LOL, wherein the selected entry comprises L0pred_cur and L1pred_cur.

16. The method of claim 1, further comprising:
deriving a first index value, V1, from one or more first syntax elements of a coded picture;
using the V1 to select a value from the L0pred_cur list;
using the selected value to identify a reference picture; and
using the identified reference picture in a motion compensation process for decoding the coded picture.

17. (canceled)

18. The method of claim 1, wherein deriving the deltaPOC value from a set of syntax elements in the bitstream comprises:
decoding a first value N3 representing a sub-GOP size from the set of syntax elements wherein the sub-GOP size is equal to 2\hat{ }N; and
deriving the deltaPOC value from the value N and a value J, wherein J is the index in the LOL comprising the current L0pred list and the current L1pred list.

19. The method of claim 1, wherein including in the L1pred_cur list the N values from the UniqueList comprises:
deriving an index value, j1, from the set of syntax elements; and
including in the L1pred_cur list the value from the entry of the UniqueList associated with the index value, j1.

20. The method of claim 1, wherein deriving the UniqueList comprises:
obtaining an initial set of values, wherein the initial set of values consists of the union of a third set of values and a fourth set of values, wherein the third set of values is equal to the first set of values with all duplicates removed and the fourth set of values is equal to the second set of values with all duplicates removed;
for each value included in the initial set of values, adding the deltaPOC value to the value included in the initial set of values, thereby producing an intermediate set of values; and
adding to the intermediate set of values the deltaPOC value, thereby producing the UniqueList.

21. The method of claim 1, wherein deriving the UniqueList comprises:
obtaining an initial set of values, wherein the initial set of values consists of i) the union of a third set of values and a fourth set of values and ii) a value equal to 0, wherein the third set of values is equal to the first set of values with all duplicates removed and the fourth set of values is equal to the second set of values with all duplicates removed;
for each value included in the initial set of values, adding the deltaPOC value to the value included in the initial set of values, thereby producing the UniqueList.

22. (canceled)

23. A computer program comprising instructions which when executed by processing circuitry of an apparatus causes the apparatus to perform the method of claim 1.

24. (canceled)

25. A decoder apparatus, the decoder apparatus comprising:
memory; and
processing circuitry, wherein the decoder apparatus is configured to perform a method comprising:
constructing a list of lists (LOL) before any coded picture that references the LOL is decoded, the LOL comprising an entry comprising i) a first previous reference picture list, the L0pred_prev list, and ii) a second previous reference picture list, the L1pred_prev list, wherein the L0pred_prev list comprises a first set of values and the L1pred_prev list comprises a second set of values, and further wherein each value included in the first set of values and the second set of values represents a reference picture indicator that can be used in the decoding process of a coded picture; and
constructing a first current reference picture list, the L0pred_cur list, and a second current reference picture list, the L1pred_cur list, based on the L0pred_prev list and the L1pred_prev list, wherein constructing the L0pred_cur list and L1pred_cur list comprises:
deriving a value, the deltaPOC value, from a set of syntax elements in the bitstream;
deriving a set of values, the UniqueList, wherein the UniqueList comprises a) the deltaPOC value and b) a third set of values, wherein each value in the third set of values is equal to either i) the sum of a value from the first set of values and the deltaPOC value or ii) the sum of a value from the second set of values and the deltaPOC value;
deriving a value N from the set of syntax elements;
deriving a value M from the set of syntax elements;
including N values from the UniqueList in the L0pred_cur list; and
including M values from the UniqueList in the L1pred_cur list.
